(19) United States
(12) Patent Application Publication
(10) Pub. No.: US 2023/0202062 A1
(43) Pub. Date: Jun. 29, 2023

(54) UTILITY CUTTER ASSEMBLIES, COMPONENTS FOR USE IN THE ASSEMBLIES, AND RELATED METHODS OF MANUFACTURING

(71) Applicant: PACIFIC HANDY CUTTER, INCORPORATED, Irvine, CA (US)

(72) Inventors: Bradley Ahrens, Muskegor, MI (US); Mark Matthews, Grand Haven, MI (US); Mark Marinovich, Rancho Santa Fe, CA (US)

(21) Appl. No.: 17/927,889

(22) PCT Filed: Jun. 6, 2020
(86) PCT No.: PCT/US2020/036514

§ 371 Date: Nov. 27, 2022

Related U.S. Application Data
(63) Continuation of application No. 16/894,762, filed on Jun. 6, 2020, now abandoned.
(60) Provisional application No. 63/030,593, filed on May 27, 2020.

(51) Int. Cl. B26B 5/00; B25G 3/34

(52) U.S. Cl. CPC B26B 5/003; B25G 3/34; B26B 5/005; B25G 1/102

(57) ABSTRACT

Utility cutter assemblies, components for use in the assemblies, and related methods of manufacturing are provided. More specifically, utility cutter assemblies, components for use in the assemblies, and related methods of manufacturing that incorporate antimicrobial materials are provided.

### CROSS REFERENCE TO RELATED APPLICATIONS

This application is related to U.S. patent application Ser. No. 16/385,110, filed Apr. 16, 2019, entitled SAFETY UTILITY BLADES, ASSEMBLIES AND METHODS OF MANUFACTURING, and Ser. No. 16/571,126, filed Sep. 15, 2019, entitled SAFETY UTILITY BLADES, ASSEMBLIES AND METHODS OF MANUFACTURING, the entire disclosures of which are incorporated herein in its entirety.

### FIELD OF THE INVENTION

The present disclosure relates to utility cutter assemblies, components for use in the assemblies, and related methods of manufacturing. More specifically, the present disclosure relates to utility cutter assemblies, components for use in the assemblies, and related methods of manufacturing that incorporate antimicrobial materials.

### BACKGROUND

Utility cutters are used for a host of purposes, such as opening cardboard boxes, cutting sheet material, cutting web material, opening packages, etc. Injuries to the users of utility cutters are all too common due to inadvertent contact with cutting edges of associated blades. Injuries may be particularly severe when a given utility knife includes a standard razor blade. Even standard, single edge, razor blades are dangerous.

Inadvertent contact with cutting edges of blades can be equally common during blade removal, insertion and handling. Inadvertent contact with the cutting edges is particularly problematic when a user is removing or inserting a double edge razor blade, or a single edge razor blade without a gripping tab, into an associated utility cutter.

As individuals become increasingly more hygiene-conscious, research has shown that nine out of ten consumers are now searching for products containing a proven and trusted antimicrobial material. Antimicrobial additives, when incorporated into plastic, may reduce bacteria by up to 99.99%, reassuring end-users that their cutter is protected and therefore less likely to harbor illness-causing bacteria. An antimicrobial material's ability to minimize microbial colonization may also reduce the potential for staining and unpleasant odors, meaning a cutter may stay fresher for longer and have an increased functional life cycle, and may offer a significant cost benefit to the consumer. For example, a silver ion antimicrobial additive may not wear off or leech from a surface of a cutter that the antimicrobial material is manufactured into, making them safe for use in a variety of products.

The global market demand for antimicrobial additives may grow significantly as a direct result of healthcare expansion in emerging countries such as China, India, Brazil, Mexico, Singapore, Saudi Arabia and Thailand. Europe may witness an increase in global volume share as a consequence of rising consumer demand for cutters that incorporate an antimicrobial material.

There may be significant rise in demand for, example, silver ion antimicrobial additives as a result of their excellent antibacterial properties, suitability for deployment in a broad range of products and low toxicological profile. Increasing awareness among consumers regarding healthcare acquired infections (HAIs) may propel the demand for cutters and cutter components containing antimicrobial additives. Demand may increase for antimicrobial materials due to their ability to increase product performance and durability.

Blades for use in utility knives, and utility knives which limit user exposure to the associated cutting edges, are desirable. Methods of manufacturing related blades and utility knives are also desirable.

What are needed are cutter components that incorporate an antimicrobial material. Cutters which include components that incorporate an antimicrobial material are also needed.

### SUMMARY

A safety cutter may include a blade, a blade attachment, and a handle. The blade may be attached to the handle via the blade attachment. At least one of: the blade attachment or the handle may include an antimicrobial material.

In another embodiment, a safety cutter may include a blade, a blade attachment, and a handle. The blade may be attached to the handle via the blade attachment. At least one of: the blade attachment or the handle may include an antimicrobial material incorporated within a plastic material. At least one of: the blade attachment or the handle further may include a metallic material encapsulated by the plastic material.

In a further embodiment, a safety cutter may include a blade and a blade attachment. The blade attachment may define a blade throat configured to limit access to a cutting edge of the blade. The safety cutter may also include a handle. The blade may be attached to the handle via the blade attachment. At least one of: the blade attachment or the handle may include an antimicrobial material.

A safety utility knife assembly may include a blade tip receptacle.

In another embodiment, safety utility knife assembly may include a redundant blade carrier locking mechanism.

In a further embodiment, a safety utility knife assembly may include a handle having a blade retainer receptacle and a blade retainer having a blade release mechanism and a blade catch, wherein the blade retainer includes a first half and a second half. The safety utility knife assembly further includes a replaceable safety blade having a blade tab and a blade securing aperture. A cutting edge of the replaceable safety blade extends perpendicular to a longitudinally extending axis of the handle. The replaceable safety blade is secured to the safety utility knife when the blade catch is engaged with the blade securing aperture. The replaceable safety blade is removable from the safety utility knife, when a user presses on the blade release mechanism and the blade catch is disengaged from the blade securing aperture.

In another embodiment, a method of manufacturing a replaceable safety blade for use within a safety utility knife assembly may include providing a strip of blade material and forming a rough blade shape from the strip of blade material. The rough blade shape may include a blade tab and a blade securing aperture. The method may further include forming a blade cutting edge in the rough blade shape.

In a further embodiment, a safety utility knife assembly may include a handle and a blade retainer having a blade release mechanism and a blade catch. The safety utility knife may further include a replaceable safety blade having a blade tab and a blade securing aperture. A cutting edge of the replaceable safety blade extends perpendicular to a longitudinally extending axis of the handle. The replaceable safety blade is secured to the safety utility knife when the blade catch is engaged with the blade securing aperture. The replaceable safety blade is removable from the safety utility knife, when a user presses on the blade release mechanism and the blade catch is disengaged from the blade securing aperture.

In yet a further embodiment, a safety utility knife assembly may include a handle having a blade retainer securing aperture and a blade retainer receptacle. The assembly may also include a blade retainer having an upwardly extending blade retainer release button extending outwardly and an upwardly extending blade retainer catch. The blade retainer release button may be received within the aperture and accessible therefrom when the blade retainer is inserted into the handle. The assembly may further include a replaceable safety blade carried by the blade retainer. The replaceable safety blade may be removable from the safety utility knife assembly when a user presses on the blade retainer release button to disengage the blade retainer catch from the blade retainer securing aperture for allowing removal of the blade retainer from the blade retainer receptacle. The blade retainer may further comprises a longitudinally extending resilient arm having one fixed end and an opposing distal end, wherein the blade retainer catch is disposed at the distal end coinciding with the blade retainer release button, wherein the resilient arm flexes at the fixed end. The blade retainer catch may move in the same direction as the blade retainer release button to release the blade retainer and the replaceable safety blade from the handle.

In another embodiment, a method of manufacturing a safety utility knife assembly may include providing a handle having an aperture, and providing a blade retainer having a blade retainer release button extending upwardly and a blade retainer catch. The blade retainer release button may be received within the aperture and is accessible therefrom when the blade retainer is inserted into the handle. The blade retainer catch and the blade retainer release button may be collocated on the blade retainer. The method may also include providing a strip of blade material, forming a rough blade shape from the strip of blade material, forming a blade securing aperture in the rough blade shape, forming a blade cutting edge in the rough blade shape to form a blade, inserting the blade in the blade retainer, inserting the blade retainer into the handle such that the blade retainer catch is received within the blade retainer securing aperture.

In a further embodiment, a safety utility knife assembly may include a handle having an aperture, and a blade retainer having an upwardly extending blade release button extending outwardly and an upwardly extending blade retainer catch. The blade release button may be received within the aperture and accessible therefrom when the blade retainer is inserted into the handle. The assembly may also include a replaceable safety blade carried by the blade retainer. The replaceable safety blade may be removable from the safety utility knife assembly when a user presses on the blade retainer release button to disengage the blade retainer catch from the blade retainer securing aperture for allowing removal of the blade retainer from the blade retainer receptacle. The blade retainer may further comprises a longitudinally extending resilient arm having one fixed end and an opposing distal end. The blade retainer catch may be disposed at the distal end coinciding with the blade retainer release button, wherein the resilient arm flexes at the fixed end. The blade retainer catch may move in the same direction as the blade retainer release button to release the blade retainer and the replaceable safety blade from the handle.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE FIGURES

FIGS. 1 and 2 depict an example safety utility knife assembly;

FIGS. 3A-3H depict various views and detail of the safety utility knife assembly of FIGS. 1 and 2;

FIGS. 4A-4H depict various views and detail of an example handle for use within the safety utility knife assembly of FIGS. 1 and 2;

FIGS. 5A-5G depict various views and detail of an example bottom half of a blade retainer for use within the safety utility knife assembly of FIGS. 1 and 2;

FIGS. 6A-6G depict various views and detail of an example top half of a blade retainer for use within the safety utility knife assembly of FIGS. 1 and 2;

FIGS. 7A and 7B depict various views and detail of an example safety blade for use within the safety utility knife assembly of FIGS. 1 and 2;

FIGS. 7C-7H depict example manufacturing methods for fabrication of the safety blade of FIGS. 7A and 7B;

FIGS. 8A and 8B depict an example safety utility blade for use within a utility knife assembly;

FIG. 9 depicts the safety utility blade of FIGS. 8A and 8B in proximity to a human finger;

FIG. 10A depicts an example progression of manufacturing the safety utility blade of FIGS. 8A, 8B and 9;

FIG. 10B depicts an example blade edge grinding and honing drum apparatus;

FIG. 10C depicts an example blade edge grinding and honing wheel;

FIG. 10D depicts an example flow diagram for a method of manufacturing the safety utility blade of FIG. 10A;

FIG. 10E depicts an example flow diagram for a method of manufacturing the safety utility blade of FIGS. 11A-11D;

FIGS. 11A-11D depict a second example progression of manufacturing the safety utility blade of FIGS. 8A, 8B and 9;

FIGS. 12A and 12B depict examples of safety cutter heads which include a safety utility blade of FIGS. 8A, 8B, 9, 10A and 11A-11D;

FIG. 13 depicts the safety cutter head of FIG. 12B proximate an associated safety utility knife handle;

FIG. 14 depicts the safety cutter head of FIG. 12B engaged with an associated safety utility knife handle to form a safety utility knife assembly;

FIGS. 15A-15H and 15J-15K depict an example safety utility knife assembly;

FIGS. 16A-16H and 16J depict an example blade carriage for use within the safety utility knife assembly of FIGS. 15A-15H and 15J;

FIG. 17A depicts an example progression of manufacturing a blade for use in the safety utility knife assembly of FIGS. 16A-16H and 16J;

FIGS. 17B-17D depict a second example progression of manufacturing a blade for use in the safety utility knife assembly of FIGS. 16A-16H and 16J;

FIG. 17E depicts an example flow diagram for a method of manufacturing the safety blade of FIG. 17A;

FIG. 17F depicts an example flow diagram for a method of manufacturing the safety blade of FIGS. 17B-17D;

FIG. 18 depicts an example safety utility blade for use in a safety utility knife assembly as in FIGS. 16A-16H and 16J;

FIGS. 19A-D depict an example safety utility knife assembly;

FIG. 20 depicts an example safety cutter assembly;

FIG. 21 depicts an example safety cutter assembly;

FIG. 22 depicts an example safety cutter assembly;

FIG. 23 depicts an example safety cutter assembly;

FIG. 24 depicts an example safety cutter assembly;

FIG. 25 depicts an example safety cutter assembly;

FIG. 26 depicts an example safety cutter assembly;

FIG. 27 depicts an example safety cutter assembly;

FIG. 28 depicts an example safety cutter assembly;

FIG. 29 depicts an example safety cutter assembly;

FIG. 30 depicts an example blade dispenser;

FIG. 31 depicts an example safety cutter assembly;

FIG. 32 depicts an example safety cutter assembly;

FIG. 33 depicts an example safety cutter assembly;

FIG. 34 depicts an example safety cutter assembly;

FIG. 35 depicts an example safety cutter assembly;

FIG. 36 depicts an example safety cutter assembly; and

FIG. 37 depicts an example safety cutter assembly.

### DETAILED DESCRIPTION

The utility blades, utility cutter assemblies and components for use within the utility cutter assemblies of the present disclosure may incorporate antimicrobial materials (e.g., antimicrobial materials integrated within plastic and/or coatings with antimicrobial materials). The utility blades, utility cutter assemblies and components for use within the utility cutter assemblies of the present disclosure may incorporate various features that limit user exposure to associated cutting edges. The manufacturing methods of the present disclosure may be used to produce the disclosed utility blades, utility cutter assemblies, and components for use within the utility cutters.

A utility cutters for use in sterile environments, and/or related components thereof, are often manufactured from stainless steel. In the food industry, for example, utility cutters are often manufactured from ferrous metals such that the utility cutter and/or component thereof may be automatically detectable/removable if accidentally introduce into food production/processes. A utility cutter manufactured from a plastic with antimicrobial material and metallic particles is particularly useful for sterile environments, and food production/processing.

An antimicrobial additive (i.e., antimicrobial material) may be incorporated into, for example, a plastic during a manufacturing process (e.g., a cutter or cutter component molding process). As used herein, an antimicrobial material is defined as a material that may resist, inhibit and prevent growth of microbes including bacteria, antibiotic resistant bacteria, viruses, bacterium, protozoan, archaea, protists, prion, viroid, fungi, yeasts, algae, mold, influenza A H1N1 virus, etc. An antimicrobial material may reduce the presence of microbes. An antimicrobial material may, for example, encompass a specific antimicrobial active, such as silver ion material, a copper material, a zinc material, triclosan and/or an organic material. The antimicrobial material may be formulated into a concentrated powder, liquid suspension or master-batch pellet depending on a target material and manufacturing process. Once infused into a cutter or cutter component, an antimicrobial material may work continuously to make the cutter more hygienic, minimizing a potential for cross-contamination and extending a cutter's functional lifetime.

There are four mains types of antimicrobial materials that are based on silver ion, copper, zinc and organic technologies: 1) silver ion antimicrobial materials suitable for deployment in a broad range of materials and applications, including paints, coatings, textiles, polymers, plastics, and other material types; 2) zinc antimicrobial materials as antibacterial and antifungal compounds; 3) copper antimicrobial materials may provide antimicrobial protection in hygienic applications, with substrates such as paints, coatings, plastics, and polymers; and 4) organic antimicrobial materials including phenolic biocides, quaternary ammonium compounds (QAC or QUAT) and fungicides (Thiabendazole). Antimicrobial material may be effective against a wide spectrum of microbes such as, bacteria, mold, viruses, bacteria, etc.

Antimicrobial material may be manufactured into a wide range of materials, including plastics, polymers, paints, coatings, textiles, ceramics and paper. Antimicrobial additives may be extremely diverse, and may control microbes via many different means. When used in the manufacture of cutter components and/or cutters, the antimicrobial material may create surfaces and materials inhospitable to microbes (e.g., E. coli, MRSA, salmonella, campylobacter, listeria, etc.).

A particular antimicrobial material is BioCote®, as available from BioCote Ltd., 3 Parade Court, Central Boulevard, Prologis Park, Coventry, CV6 4QL, United Kingdom. Other suitable antimicrobial materials are SANAFOR® PO-5, EBA-10, and PS-10, as available from Janssen Preservation and Material Protection (Janssen PMP), a division of Janssen Pharmaceutica NV, a Johnson & Johnson company, 1125 Trenton-Harbourton Rd., Titusville, N.J. 08560-0200.

BioCote® antimicrobial protection may be, for example, suitable for a range of plastic and polymer materials. An associated antimicrobial protection range may include antimicrobial additives for plastics. These antimicrobial materials may be, for example, integrated into a plastic material during a manufacturing process to provide lasting protection from microbes. An additive may encompass a specific antimicrobial active, such as silver (e.g., silver ion), and may be formulated into a concentrated powder, liquid suspension or masterbatch pellet depending on the type of plastic, the manufacturing process and/or a desired end-use of an associated cutter and/or cutter component. An antimicrobial material may be, for example, incorporated into various types of plastics (e.g., acrylonitrile butadiene styrene (ABS), general purpose polystyrene (GPPS), melamine formaldehyde (MF), polycaprolactam/Nylon (PA6), Nylon 66, polyacrylamide (PARA), polybutylene terephathalate (PBT), polyether ether ketone (PEEK), polyethermide (PEI), polyethylene naphthalate (PEN), polyethylene terephythalate (PET), poly(methyl methacrylate) (PMMA), polyoxymethylene (POM), polysulfone (PDU), polytetrafluoroethylene (PTFE), styrene acrylonitrile (SAN), polystyrene butadiene styrene (SBS), urea formalydehyde (UF), epoxy, chlorinated polyethylene (CPE), ethylene propylene diene monomer (EPDM), high-density polyethylene (HPDE), low-density polyethylene (LDPE), linear low-density polyethylene (LLDPE), medium-density polyethylene (MDPE), poluchloroprene/neoprene (PCP), ethylene vinyl acetate (EVA), high impact polystyrene (HIPS), polyethylene (PE), polymethyl methacrylate (PMMA), polypropylene (PP), polyurethane (PU), polycarbonate (PC), polystyrene (PS), polyvinyl chloride (PVC), silicone, thermoplastic polyurethane (TPU), etc.).

Notably, resin types, for manufacturer of any given component, as described herein, may include any one of the variations of polyethylene and polypropylene. A resin may be include within the meaning of the word “polyolefin'. Polystyrene, ABS, GPPS, PVC, etc. may fall under the category of “commodity thermoplastics” (this includes polyolefins). PC, PBT, TPU, nylon, POM, etc. may be considered “engineering thermoplastics”. “High temperature” may be product like polysulfone, PEI, PEEK, PPS, etc. Items like Urea, epoxy, phenolic, silicone may be considered ‘thermosets’. Any given component may be manufactured of any one of the families of plastic: 1) Commodity TP, 2) Engineering TP, 3) High Heat TP, and/or 4) Thermosets. TPE, for example, may apply to several types and chemistries; TPE may be considered to be commodity or engineering depending the type and manufactuing or commercial pursuits of the product.

SANAFOR® PO-5 may be incorporated into, for example, Linear Low Density Polyethylene (LLDPE), Low Density Polyethylene (LDPE), High Density Polyethylene (HDPE), Polypropylene (PP-copolymer), Polypropylene (PP-homopolymer), Ethylene Vinyl Acetate (EVA) Copolymer, Ethylene Butyl Acrylate (EBA), Thermoplastic Elastomer (TPE), etc. SANAFOR® EBA-10 may be incorporated into, for example, Polyethylene (PE), Polypropylene (PP), Polyacrylate (PA), Polystyrene (PS), Polycarbonate (PC), Polyethylene Terephthalate (PET), Polybutylene Terephthalate (PBT), Polyvinyl Chloride (PVC), Acrylonitrile Butadiene Styrene (ABS) Poly, etc.

SANAFOR® PS-10 may be incorporated into, for example, General Purpose Polystyrene (GPPS), High Impact Polystyrene (HIPS), Poly(Styrene Acrylonitrile) (SAN), Poly(Styrene Butadiene Styrene) (SBS), Methyl methacrylate-acrylonitrile-butadiene-styrene (MABS), and Acrylic Styrene Acrylonitrile (ASA) Poly.

Alternatively, or additionally, an antimicrobial material may be as available from Microban International, Ltd., 11400 Vanstory Drive, Huntersville, N.C. 28078. An antimicrobial material may provide lasting and effective protection against harmful bacteria, mold, fungi and viruses by up to 99.99%, minimizing risk of staining, bad odors and material degradation. Once infused into a plastic, a silver ion antimicrobial additive may, for example, not leech from an associated surface, cause discoloration or affect the clarity of the associated plastic. An antimicrobial plastic material may last for an expected lifetime of an associated cutter and/or cutter component.

An antimicrobial material may control and/or reduce microbe presence on a protected surface. For example, an antimicrobial material, incorporated within a cutter or cutter component, may perform across a wide range of microbes (e.g., bacteria, antibiotic resistant bacteria, viruses, fungi, yeasts, algae, mold, etc.). An antimicrobial material may reduce antibiotic resistant bacteria (e.g., CRE Klebsiella kleb-zee-el-uh, ESBL producing Escherichia coli, MRSA, Methicillin-resistant Staphylococcus aureus, VRE, etc.). An antimicrobial material may reduce bacteria (e.g., Acinetobacter Baumannii As-sin-ee-toe-bac-ter, bau-mahn-ee-eye, Campylobacter cam-py-lo-back-ter, Chelatococcus asaccharovorans, etc.). An antimicrobial material may reduce mold and fungi (e.g., Aspergillus niger (as-per-jil-uh s nahy-jer), Candida albicans (kan-di-duh al-bee-cans), Penicillium sp. (pen-uh-sil-ee-uh m), etc.).

An antimicrobial material may contain a fine particle size (e.g., a silver based antimicrobial powder dispersed in thermoplastic carriers). Master-batch pellets may be, for example, designed to be let down at 4 wt. % Let Down Ratio (LDR) into various resins to impart antimicrobial properties to an associated cutter component or cutter. Master-batch products may be selected based on pairing a compatibility of the master-batch carrier with a resin that the master-batch is being let down into. For example, an antimicrobial powder may be custom compounding into a thermoplastic carrier resin of choice.

Antimicrobial master-batch pellets may be physically mixed with, for example, a desired thermoplastic resins at 4 wt. % prior to drying. The mixed pellets may then be dried at a maximum temperature of, for example, 180° F. to moisture levels of less than 0.05 wt. % for PEBA or polyamides, or less than 0.02 wt. % for TPU resins. Polyether block amide (PEBA) is a thermoplastic elastomer (TPE). Thermoplastic polyurethane (TPU) is any of a class of polyurethane plastics with many properties, including elasticity, transparency, and resistance to oil, grease and abrasion. Technically, thermoplastic polyurethane (TPU) are thermoplastic elastomers consisting of linear segmented block copolymers composed of hard and soft segments. Alternatively, master-batch pellets may be dried separately and mixed afterwards. For materials that are very sensitive to hydrolytic degradation, dried mixtures of pellets may be transferred directly from an associated dryer to a hopper feeder with a blanket of inert gas during processing. A 4 wt. % addition of an antimicrobial master-batch to bulk resin may not significantly influence associated plastic processing parameters. For example, associated processors start with nominal processing conditions for the selected material. However, subtle adjustments, such as increasing back pressure in an injection molding process, may achieve homogenous incorporation of an antimicrobial master-batch into a bulk resin. Similarly, cooling at an associated feed-port may prevent occurrence of bridging. A silver ion based antimicrobial material may not, use any nanoparticles, and may, for example, use a 4% let down ration in an ethylene methyl acrylate (EMA) based resin copolymer.

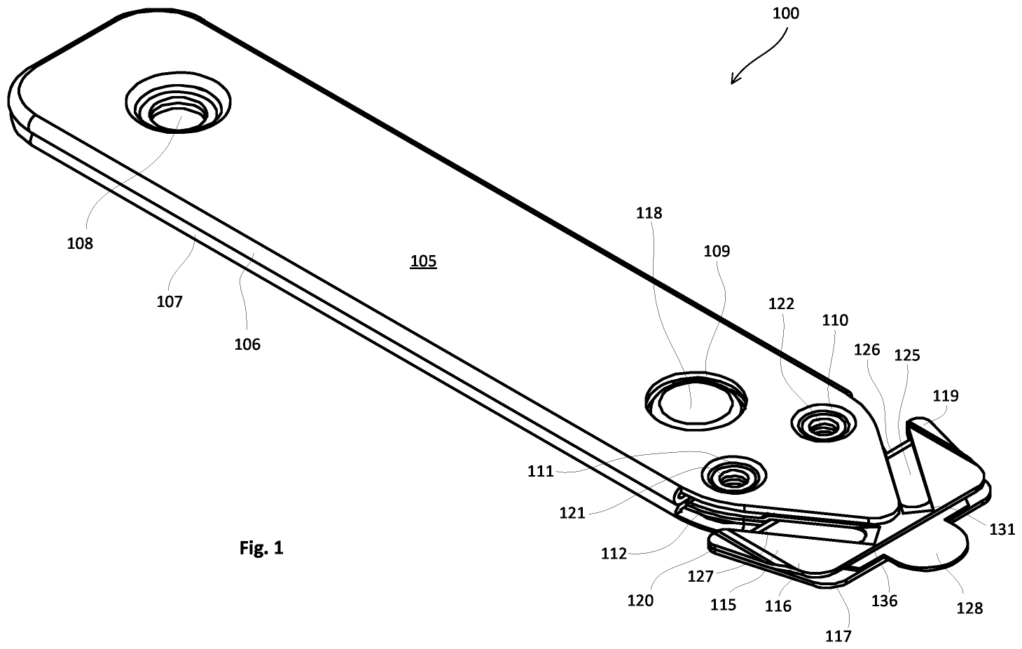

With initial reference to FIG. 1, a safety utility knife assembly 100 may include a replaceable safety blade 125. As described in detail herein, the replaceable safety blade 125 may be inserted into a blade retainer 112 which, in turn, may be inserted into a blade retainer receptacle 112 of an associated handle 105. The safety utility knife 100 may include a blade release button 118. The replaceable safety blade 125 may include a blade tab 128. A user may remove the replaceable safety blade 125 from the safety utility knife assembly 100 by, for example, grasping the blade tab 128, pressing the button 118, and pulling the replaceable safety blade 125 from the blade retainer 115.

The handle 105 may include a first half 106 secured to a second half 107 forming, for example, the blade retainer receptacle 112 in one end for receiving a blade retainer 115. The handle 105 may include an aperture 108 for hanging the safety utility knife assembly 100 on, for example, a peg or hanger of some sort. Alternatively, or additionally, the safety utility knife assembly 100 may be secured to a clip of, for example, a lanyard , a strap, a key chain, etc. (not shown). The handle 105 may include blade retainer receptacles 110, 111 configured to receive, for example, blade retainer snaps 121, 122, respectively. The blade retainer 115 may include a first half 116 and a second half 117. The first half 116 of the blade retainer 115 may include a first blade end offset 119, a second blade end offset 120, a first wedge 131, and a second wedge 136. The first wedge 131 and the second wedge 135 may be configured to, for example, prevent, or minimize, material buildup. The safety utility blade 125 may include a first cutting edge 126 and a second cutting edge 127. Alternatively, the first and second cutting edges 126, 127 of a safety utility blade 125 may define a single, continuous, cutting edge. Further details of the handle 105, the blade retainer 115, and the replaceable safety blade 125 are described throughout this disclosure.

Advantageously, when either of the first or second cutting edge 126, 127 becomes dull, or worn, a user may simply flip the safety utility knife assembly 100 over and use the other cutting edge 126, 127. When both the first cutting edge 126 and the second cutting edge 127 are dull, or worn, a user may simply replace the replaceable safety blade 125 while reusing other components (e.g., handle 105 and safety utility blade retainer 115) of the safety utility knife assembly 100.

The safety utility knife assembly 100 may include a handle 105 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 100 may include a blade retainer 115 injection molded of a nylon (e.g., polycaprolactam/Nylon (PA6), Nylon 66, etc.) with a second antimicrobial material (e.g., a BioCote® silver ion material) incorporated within the nylon. Additionally, or alternatively, the handle 105 and/or the blade retainer 115 may include an overmold (e.g., thermoplastic elastomer (TPE)) with a third antimicrobial material (e.g., a BioCote®, SANAFOR® PO-5, SANAFOR® EBA-10, or SANAFOR® PS-10). The replaceable safety blade 125 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 105 and/or the blade retainer 115 may include a metallic material embedded in the associated plastic material.

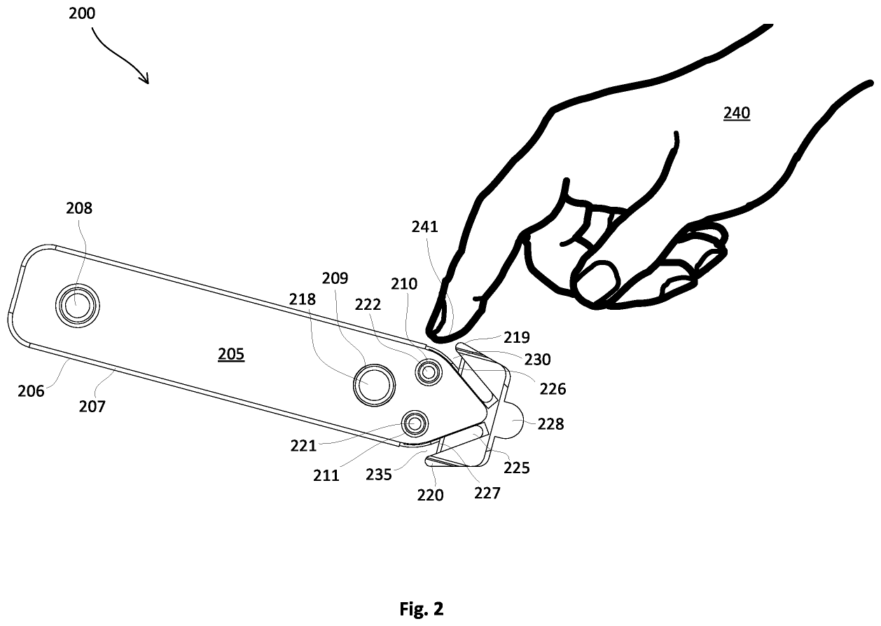

Turning to FIG. 2, a safety utility knife assembly 200 may include a first blade throat 230 defined by a first blade retainer tip 219 and a proximate portion of a blade handle 205. The safety utility knife assembly 200 may be similar to, for example, the safety utility knife 100 of FIG. 1. In any event, the safety utility knife assembly 200 may include a second blade throat 235 defined by a second blade retainer tip 220 and a proximate portion of a blade handle 205. The first blade throat 230 may be configured to, for example, limit access of a finger 241 of a hand 240 of a user to a first cutting edge 226 of an associated blade 225. Similarly, the second blade throat 235 may be configured to limit exposure to a second cutting edge 227.

The safety utility knife assembly 200 may include a blade release button 218. The replaceable safety blade 225 may include a blade tab 228. A user may remove the replaceable safety blade 225 from the safety utility knife assembly 200 by, for example, grasping the blade tab 228, pressing the button 218, and pulling the replaceable safety blade 225 from the blade handle 205. The handle 205 may include a first half 206 secured to a second half 207 for receiving a replaceable safety blade 225. The handle 205 may include an aperture 208 for hanging the safety utility knife assembly 200 on, for example, a peg or hanger of some sort. Alternatively, or additionally, the safety utility knife assembly 200 may be secured to a clip of, for example, a lanyard, a strap, a keychain, etc. (not shown). The handle 205 may include blade retainer receptacles 210, 211 configured to receive, for example, blade retainer snaps 221, 222, respectively. Further details of the handle 205 and the replaceable safety blade 225 are described throughout this disclosure.

The safety utility knife assembly 200 may include a handle 205 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 200 may include a blade retainer 215 injection molded of a nylon (e.g., polycaprolactam/Nylon (PA6), Nylon 66, etc.) with a second antimicrobial material (e.g., a BioCote® silver ion material) incorporated within the nylon. Additionally, or alternatively, the handle 205 and/or the blade retainer 215 may include an overmold (e.g., thermoplastic elastomer (TPE)) with a third antimicrobial material (e.g., a BioCote®, SANAFOR® PO-5, SANAFOR® EBA-10, or SANAFOR® PS-10). The replaceable safety blade 225 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 205 and/or the blade retainer 215 may include a metallic material embedded in the associated plastic material.

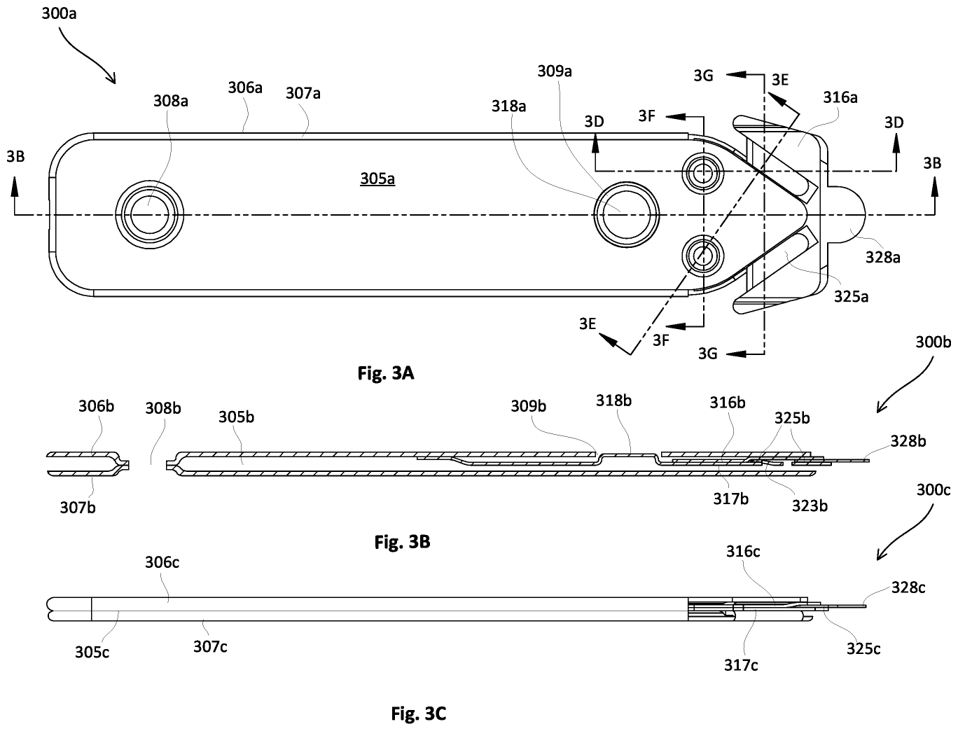

With reference to FIGS. 3A-3H, a safety utility knife assembly 300a-h, may include a replaceable safety blade 325a-e, 325g, 325h retained by a handle 305a-c. The safety utility knife assembly 300a-h may be similar to, for example, either the safety utility knife assembly 100 of FIG. 1 or the safety utility knife assembly 200 of FIG. 2. The cross-section view of the safety utility knife 300b of FIG. 3B is taken along the section-line 3B-3B of FIG. 3A. The cross-section view of the safety utility knife 300d of FIG. 3D is taken along the section-line 3D-3D of FIG. 3A. The cross-section view of the safety utility knife 300e of FIG. 3E is taken along the section-line 3E-3E of FIG. 3A. The cross-section view of the safety utility knife 300f of FIG. 3F is taken along the section-line 3F-3F of FIG. 3A. The cross-section view of the safety utility knife 300g of FIG. 3G is taken along the section-line 3G-3G of FIG. 3A.

The handle 305a-c may include a first half 306a-h secured to a second half 307a-h, a first aperture 308a, 308b, a second aperture 309a, 309b, 309h, a third aperture 311h, and a fourth aperture 311h. The safety utility knife assembly 300a-h may include a first blade retainer half 316a-h having a first wedge 331h and a second wedge 336h, and a second blade retainer half 317a-h having a blade release button 318a, 318b, a blade retention catch 323g, 323h, a first blade retainer pin 321f, 321h, and a second blade retainer pin 322f, 322h. The replaceable safety blade 325a-e, 325g, 325h may include a blade tab 328a-c, 328h and a blade retention aperture 329g, 329h. The replaceable safety blade 325a-e, 325g, 325h may be retained within the safety utility knife assembly 300a-h when the blade retention catch 323g, 323h is received within the blade retention aperture 329g, 329h. The safety utility knife assembly 300a-h may include a first blade throat 330h configured to, for example, limit access to a first cutting edge 326h. Similarly, the safety utility knife assembly 300a-h may include a second blade throat 335h configured to limit exposure to a second cutting edge 327h.

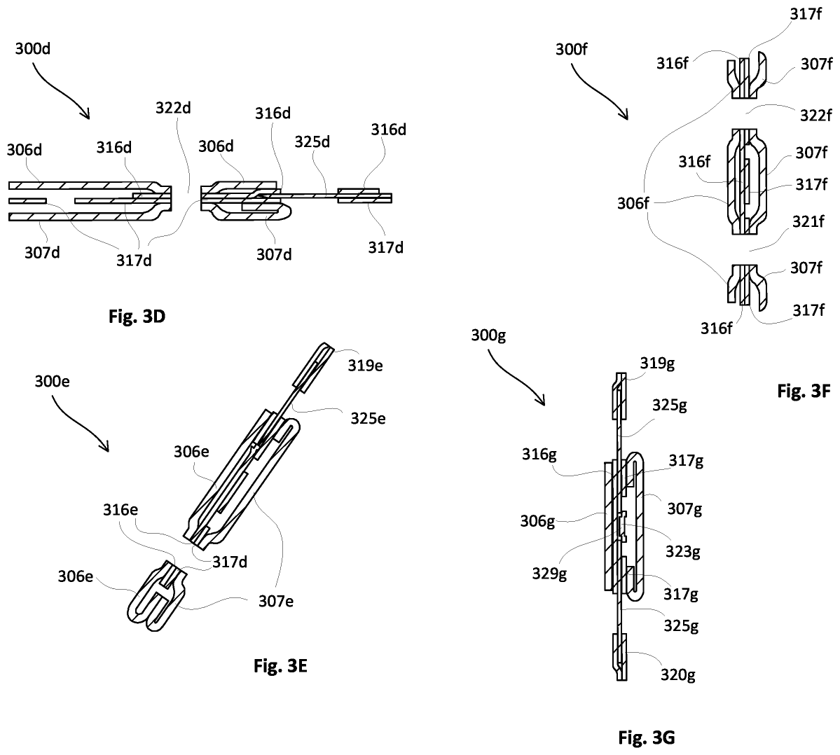

Turning to FIGS. 4A-4H, a handle 400a-h for use within a safety utility knife assembly (e.g., safety utility knife assembly 100 of FIG. 1, safety utility knife assembly 200 of FIG. 2, or safety utility knife assembly 300a-h of FIGS. 3A-3H) may include a first half 406e-h and a second half 407a-d. The first half 406e-h may be similar to, for example, the first half 106 of FIG. 1 or the first half 206 of FIG. 2. The second half 407a-d may be similar to, for example the second half 107 of FIG. 1 or the second half 207 of FIG. 2. The cross-section view of the first half 406h of FIG. 4H is taken along the section-line 4H-4H of FIG. 4E. The cross-section view of the first half 406g of FIG. 4G is taken along the section-line 4G-4G of FIG. 4E. The cross-section view of the second half 407c of FIG. 4C is taken along the section-line 4C-4C of FIG. 4A. The cross-section view of the second half 407e of FIG. 4E is taken along the section-line 4E-4E of FIG. 4A. The first half 406e-h may include a first aperture 408e, 408h, a second aperture 409e, a third aperture 411e, 411g, and a fourth aperture 412e, 412h. The second half 407a-d may include a first aperture 408a, 408g, a second aperture 411a, 411c, and a third aperture 412a, 412c.

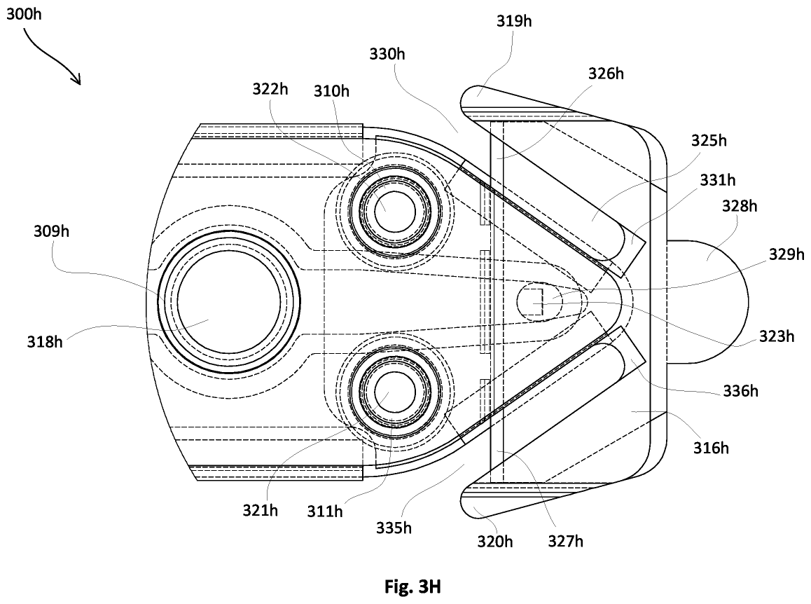

With reference to FIGS. 5A-5G, first half 500a-g of a blade retainer (e.g., blade retainer 115 of FIG. 1) for use within the safety utility knife (e.g., safety utility knife assembly 100 of FIG. 1, safety utility knife assembly 200 of FIG. 2, or safety utility knife assembly 300a-h of FIGS. 3A-3H). The first half 500a-g may be similar to, for example, the first half 116 of FIG. 1, the first half 216 of FIG. 2, or the first half 316a-h of FIGS. 3A-3H. The cross-section view of the first half 500g of FIG. 5G is taken along the section-line 5G-5G of FIG. 5B. The cross-section view of the first half 500c of FIG. 5C is taken along the section-line 5C-5C of FIG. 5D.

The first half 500a-g may include a first blade throat 530a, 530b, 530e configured to, for example, limit access to a first cutting edge (e.g., first cutting edge 126 of FIG. 1, first cutting edge 226, or first cutting edge 326h of FIG. 3H). Similarly, the first half 500a-g may include a second blade throat 535a, 535b, 535e configured to, for example, limit access to a second cutting edge (e.g., first cutting edge 127 of FIG. 1, second cutting edge 226, or second cutting edge 326h of FIG. 3H). The first half 500a-g may include a blade release button 518a-f and a blade retention catch 523a-f pivotally attached via a flex 543a-b, 543d. The first half 500a-g may include a first spacer/retainer 540a-f, a second spacer/retainer 541a-e, and a third spacer/retainer 542a-d, 542f. The first spacer/retainer 540a-f, the second spacer/retainer 541a-e, and the third spacer/retainer 542a-d, 542f may be configured to secure the first half 500a-g within an associated safety utility knife assembly (e.g., safety utility knife assembly 100 of FIG. 1, safety utility knife assembly 200 of FIG. 2, or safety utility knife assembly 300a-h of FIGS. 3A-3H).

The first half 500a-g may include a first wedge 532b, 532g and a second wedge 537b. As illustrated in FIG. 5G, the first wedge 532h, 532g may define a ten degree angle with respect to a surface 516f of the first half 500a-g. More generally, the first wedge 532h, 532g may define between a five and fifteen degree angle with respect to a surface 516f of the first half 500a-g. The second wedge 537b may be, for example, similar to the first wedge 532b, 532g.

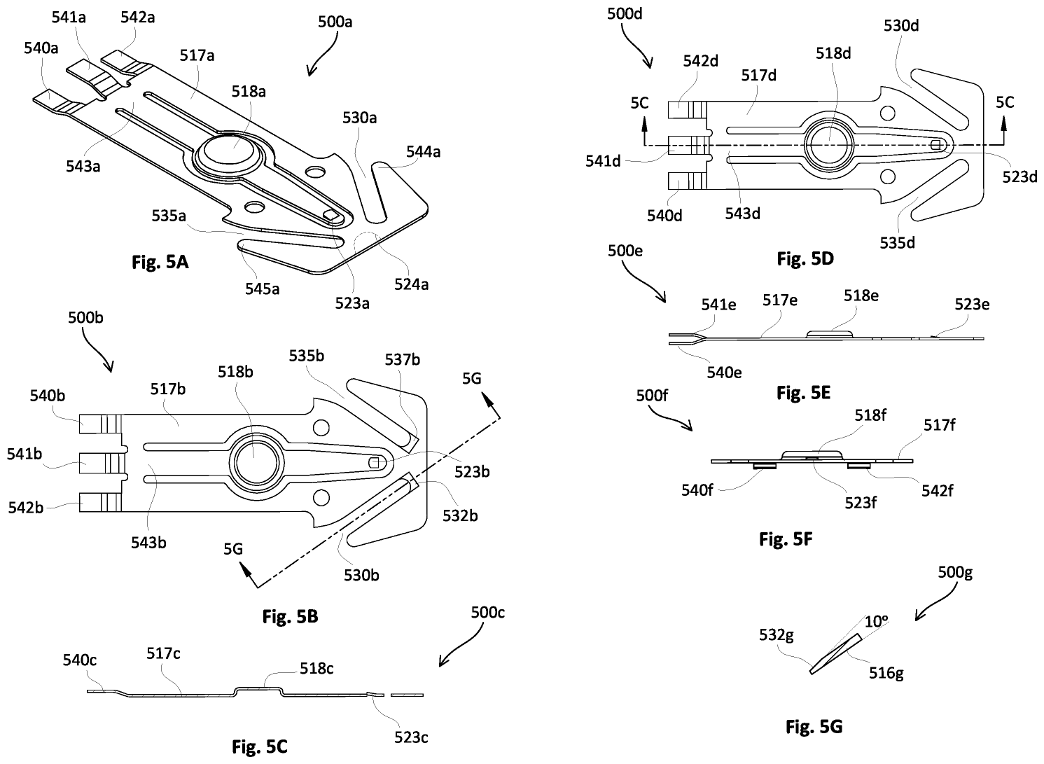

As illustrated by the dashed line in FIG. 5A, the first half 500a-g, may include a finger/thumb blade access 524a configured to allow use of a safety blade (not shown in FIGS. 5A-5G), that, for example, does not include a blade tab (e.g., blade tab 128 of FIG. 1). In such an embodiment, a user may remove an associated replaceable safety blade by grasping a portion of the replaceable safety blade within the finger/thumb blade access 524a. Thus, an associated safety utility knife assembly (e.g., safety utility knife assembly 100 of FIG. 1, safety utility knife assembly 200 of FIG. 2, or safety utility knife assembly 300a-h of FIGS. 3A-3H) may include any readily available replaceable blade having a blade securing hole (e.g., blade securing hole 746c3 of FIG. 7C).

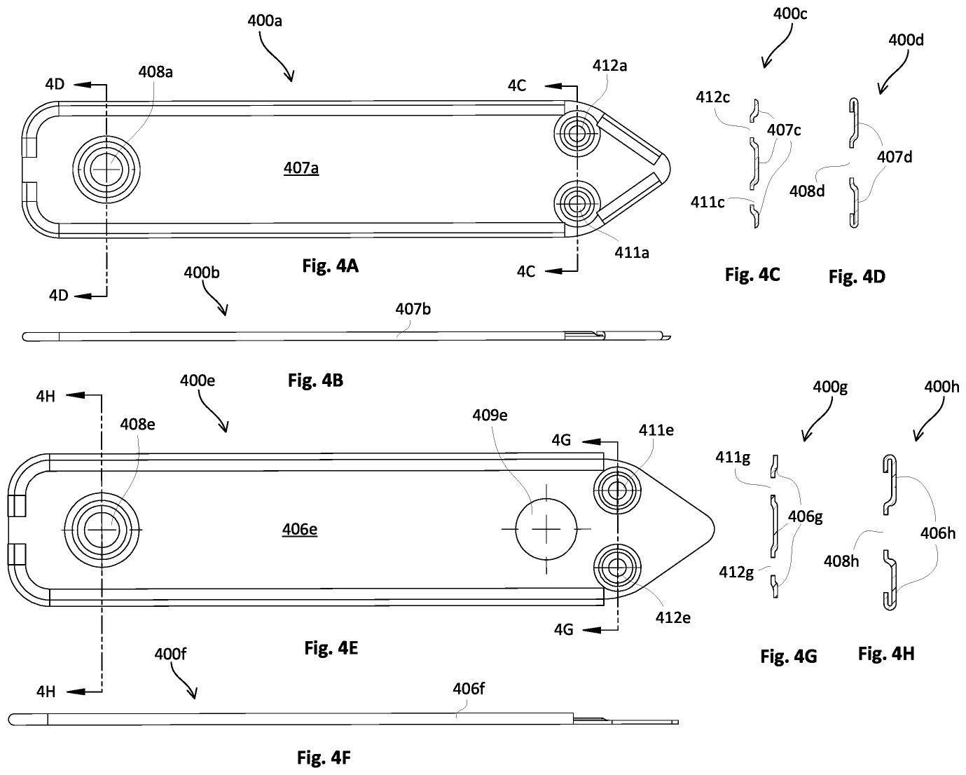

Turning to FIGS. 6A-6G, a second half 600a-g of a blade retainer (e.g., blade retainer 115 of FIG. 1) for use within the safety utility knife (e.g., safety utility knife assembly 100 of FIG. 1, safety utility knife assembly 200 of FIG. 2, or safety utility knife assembly 300a-h of FIGS. 3A-3H). The second half 600a-g may include a body 617a-g, a first blade throat 630a, 630c, and a second blade throat 635a, 635c. The second half 600a-g may include dimensions as shown in FIG. 6B, however, any the second half 600a-g may include any other suitable dimensions as long as an associated first half and an associated safety blade are provided with corresponding dimensions.

The second half 600a-g may include a first wedge 633a-b, 633e, 633g and a second wedge 638a-b. As illustrated in FIG. 6G, the first wedge 633a-b, 633e, 633g may define a ten degree angle with respect to a body 617g of the first half 600a-g. More generally, the first wedge 633a-b, 633e, 633g may define between a five and fifteen degree angle with respect to a surface 617g of the first half 600a-g. The second wedge 638a-b may be, for example, similar to the first wedge 633a-b, 633e, 633g.

As illustrated by the dashed line 624a in FIG. 6A, the second half 600a-g, may include a finger/thumb blade access 624a configured to allow use of a safety blade (not shown in FIGS. 6A-6G), that, for example, does not include a blade tab (e.g., blade tab 128 of FIG. 1). In such an embodiment, a user may remove an associated replaceable safety blade by grasping a portion of the replaceable safety blade within the finger/thumb blade access 624a. Thus, an associated safety utility knife assembly (e.g., safety utility knife assembly 100 of FIG. 1, safety utility knife assembly 200 of FIG. 2, or safety utility knife assembly 300a-h of FIGS. 3A-3H) may include any readily available replaceable blade having a blade securing hole (e.g., blade securing hole 746c3 of FIG. 7C).

With reference to FIGS. 7A and 7B, a safety blade 700a, 700b for use within the safety utility knife (e.g., safety utility knife assembly 100 of FIG. 1, safety utility knife assembly 200 of FIG. 2, or safety utility knife assembly 300a-h of FIGS. 3A-3H) may include a first cutting edge 726a, a second cutting edge 727a, 727b, and a blade tab 728a, 728b. The first cutting edge 726a and the second cutting edge 727a, 727b may define a single, continuous cutting edge. The safety blade 700a, 700b may be similar to, for example, the safety blade 125, 225 of FIGS. 1 and 2, respectively. In lieu of the safety blade 700a, 700b, a blade in accordance with any of the blades described and mentioned in commonly assigned U.S. patent application Ser. No.: 13/866,074, along with an associated blade retainer, may be used with the handle 400a-400h and 400j of FIGS. 4A-4H and 4J, respectively. The safety blade 725a, 725b may include dimensions as shown in FIGS. 7A and 7B or, alternatively, may include any suitable dimensions provided associated a blade retainer are provided with corresponding dimensions.

Turning to FIGS. 7C and 7H, a manufacturing method for fabrication of the replaceable safety blade of FIGS. 7A and 7B for use in a safety utility knife assembly (e.g., safety utility knife assembly 100 of FIG. 1, safety utility knife assembly 200 of FIG. 2, or safety utility knife assembly 300a-h of FIGS. 3A-3H) may include providing a strip of blade material 700c (block 770g). A rough blade shape 710c1 may be formed by removing material 750a (block 775g). A blade securing hole 746c3 may be formed in the rough blade shape 710c1 by any suitable method, such as laser cutting, water jet cutting, machining, drilling, stamp shearing, etc. (block 780g). A sharpened portion 740c2, 740c3 may be formed by any suitable method, such as those disclosed in U.S. Pat. Nos. 4,265,055, 5,842,387, 6,860,796 or 8,206,199, for example (block 785g). The sharpened portion 740c2, 740c3 may define a shoulder 741c2, 741c3 and a cutting edge 742c2, 742c3. The blade 710c3 may be separated from the strip of blade material 700c by removing material 752c, 753c (block 790g). A blade end 751c may form an angle 713c with respect to a linear edge of the strip of blade material 700c of approximately 60°. Alternatively, the angle 713c may be between approximately 55° and approximately 70°.

With reference now to FIGS. 7D-7F and 7H, a method 700h of manufacturing a blade 710a, 710b for use in a safety utility knife assembly (e.g., safety utility knife assembly 100 of FIG. 1, safety utility knife assembly 200 of FIG. 2, or safety utility knife assembly 300a-h of FIGS. 3A-3H) may include blade blanks 700d that may be formed from a strip of blade material 700c (block 775h). Rough blade shapes 710d may be formed from the blade blanks 700d (block 780h). A blade securing hole 746f may be formed in the rough blade shape 700d by any suitable method, such as laser cutting, water jet cutting, machining, drilling, stamp shearing, etc. (block 785h). A sharpened portion 740e, 740f may be formed on a blade blank 710e, 710f by any suitable method, such as those disclosed in U.S. Pat. Nos. 4,265,055, 5,842,387, 6,860,796 or 8,206,199, for example (block 790h). The sharpened portion 740e, 740f may define a shoulder 741e, 741f and a cutting edge 742e, 742f.

A safety utility knife assembly (e.g., safety utility knife assembly 100 of FIG. 1, safety utility knife assembly 200 of FIG. 2, or safety utility knife assembly 300a-h of FIGS. 3A-3H) for use in, for example, a food industry may include a handle (e.g., handle 105 of FIG. 1), a replaceable safety blade retainer (e.g., replaceable safety blade retainer 115 of FIG. 1), and a replaceable safety blade (e.g., replaceable safety blade 125 of FIG. 1) that are each made from, for example, metal such that any portion of, or all of, the safety utility knife assembly 100 that is, for example, dropped into a batch of associated food may be detected and/or removed via associated metal detection/removal equipment.

A safety utility knife assembly (e.g., safety utility knife assembly 100 of FIG. 1, safety utility knife assembly 200 of FIG. 2, or safety utility knife assembly 300a-h of FIGS. 3A-3H) may include various features as described, for example, in commonly assigned U.S. patent application Ser. No. 12/620,999, which was filed on Nov. 18, 2009, and U.S. patent application Ser. No. 13/866,074, which was filed on Apr. 19, 2013, the disclosures of which are incorporated in their entireties herein by reference thereto.

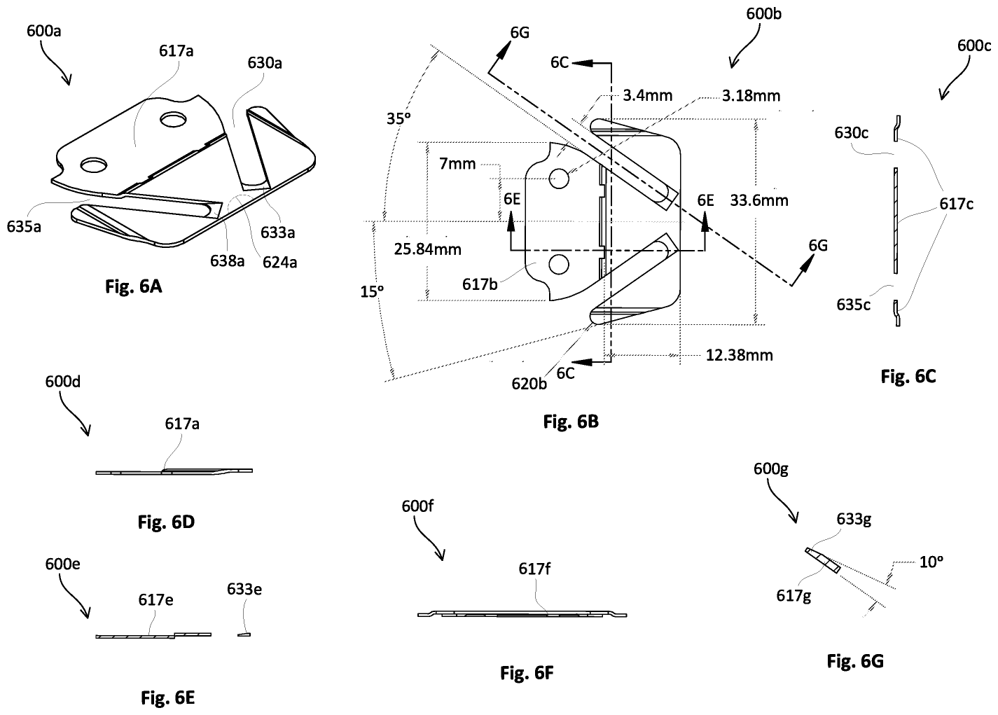

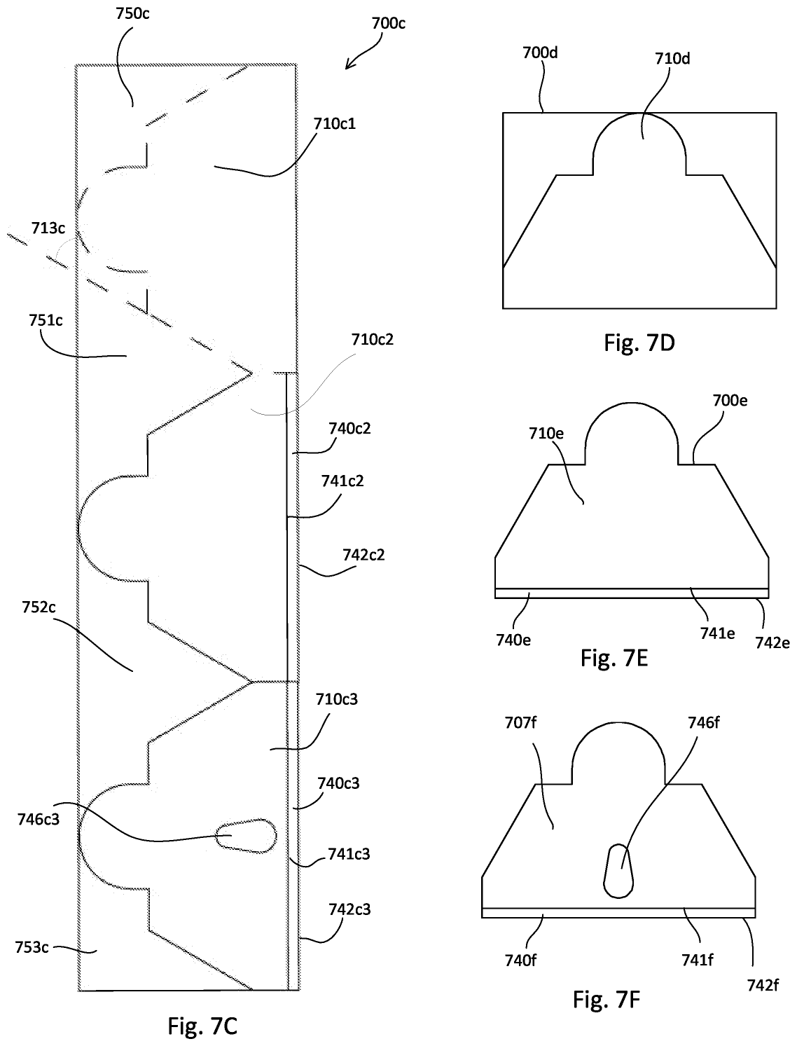

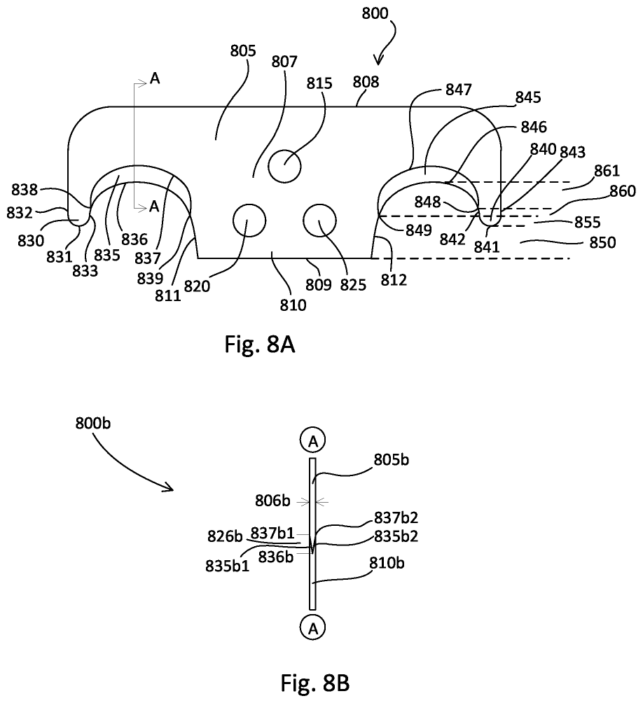

With initial reference to FIGS. 8A and 8B, a safety utility blade 800 may have a body 805 formed from a relatively thin and substantially flat material 807, such as ceramic, heat treated carbon steel, ceramic coated steel, stainless steel, Teflon coated material, etc. For example, the material 807 may be approximately 0.025 inches thick 806b. A blade blank (e.g. blade blank 1000a, 1100a, 1700a, 1700b of FIGS. 10A, 11A, 17A and 17B, respectively) may be 1.0964567 inches from a first end 832 to a second end 842 and 0.3917323 inches from a top side 808 to a bottom side 809. The safety utility blade may include blade securing holes 815, 820, 825 which may be approximately 0.0984252 inches in diameter. As described herein the blade securing holes 815, 820, 825 may, at least in part, secure a safety utility blade 800 to a safety utility knife cutting head (e.g., safety utility knife cutting head 1200a of FIG. 12A or 1200b of FIG. 12B). The safety utility blade 800 may be formed from a suitable material 807 for retaining a sharpened edge 836, 837, and, when that material 807 is metal, the body 805 preferably has a thickness 806b of at least 0.0156 inches and preferably not greater than about 0.0313 inches. What might be characterized as a “heavy-duty” safety utility blade 800 is approximately 0.025 inches thick, and the thickness 806b for what might be characterized as a “regular duty” safety utility blade 800 is approximately 0.017 inches. The sharpened portion 135, 145 is approximately 0.0492 inches high. A center of the first blade securing hole 815 may be approximately 0.23622 inches from the bottom side 809 and approximately 0.54825 inches from the first end 832. A center of the second blade securing hole 820 may be approximately 0.07874 inches from the bottom side 809 and approximately 0.449825 inches from the first end 832. A center of the third blade securing hole 825 may be approximately 0.07874 inches from the bottom side 809 and approximately 0.449825 inches from the second end 842. The sharpened portion 835, 845 may be coated with a material, such as paint, that may wear away as the associated safety utility blade 800 is being used to indicate whether the safety utility blade 800 has been used. The consistency of the material, such as paint, may be selected such that the amount of wear of the material is indicative of the amount of use of and/or the sharpness of the safety utility blade 800.

With further reference to FIGS. 8A and 8B, the safety utility blade 800 may include a body portion 805, 805b and a blade attachment portion 810, 810b. The first sharpened portion 835 of the safety utility blade 800 may include a first shoulder 837, a first cutting edge 836, a first heal 839 and a first toe 838. The blade attachment portion 810, 810b may include a first edge 811 extending from the first heal 839 to the bottom side 809. The safety utility blade 800 may further include a first blade shield 830 having a first blunt tip 831 having a radius approximately 0.03937 inches and a thickness that is greater than the first sharpened portion 835 and less than or equal to the thickness 806b of the body 805. The first blade shield 830 may include a first inner edge 833 that extends from the first toe 839 to the first blunt tip 831 and may have a thickness that is greater than the first sharpened portion 835 and less than or equal to the thickness 806b of the body 805, 805b. A first distance 826b between the first shoulder 837 and the first cutting edge 836 may be approximately 0.04921 inches.

With further reference to FIGS. 8A and 8B, the safety utility blade 800 may include a second sharpened portion 845 which may include a second shoulder 847, a second cutting edge 846, a second heal 849 and a second toe 848. The blade attachment portion 810, 810b may include a second edge 812 extending from the second heal 849 to the bottom side 809. The safety utility blade 800 may further include a second blade shield 840 having a second blunt tip 841 having a radius approximately 0.03937 inches and a thickness that is greater than the second sharpened portion 845 and less than or equal to the thickness 806b of the body 805. The second blade shield 840 may include a second inner edge 843 that extends from the second toe 849 to the second blunt tip 841 and may have a thickness that is greater than the second sharpened portion 845 and less than or equal to the thickness 806b of the body 805. A second distance 850 between the bottom side 809 and the second blunt tip 841 may be approximately 0.05315 inches. A third distance 855 between the bottom side 809 and the second heal 849 may be approximately 0.0687 inches. A fourth distance 860 between the bottom side 809 and the second toe 848 may be approximately 0.0774 inches. A fifth distance 861 between the bottom side 809 and the second cutting edge 846 may be approximately 0.1496 inches. As depicted in FIG. 8B, the cutting edge 836b may be defined by a third sharpened portion 835b1 extending from a third shoulder 837b1 and a fourth sharpened portion 835b2 extending from a fourth shoulder 837b2. It should be understood that either of the cutting edges 836, 846 may be formed similar to cutting edge 836b. The sharpened portion 835, 845, the third sharpened portion 835b1 and/or the fourth sharpened portion 835b2 may be substantially concave or convex shaped. Alternatively, a portion of the sharpened portion 835, 845, a portion of the third sharpened portion 835b1 and/or a portion of the fourth sharpened portion 835b2 may be substantially concave or convex shaped with the remainder defining a linear shape.

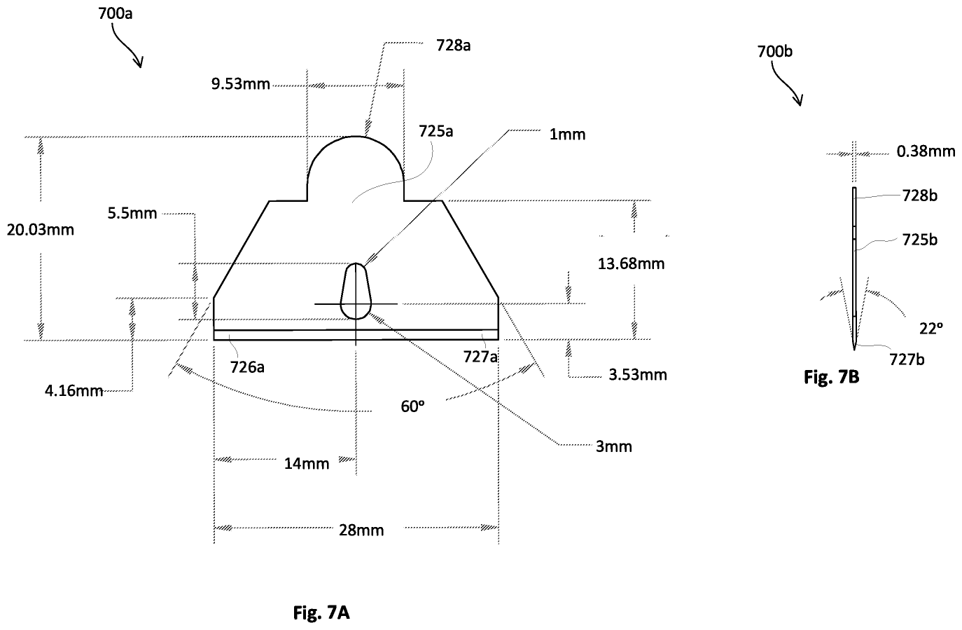

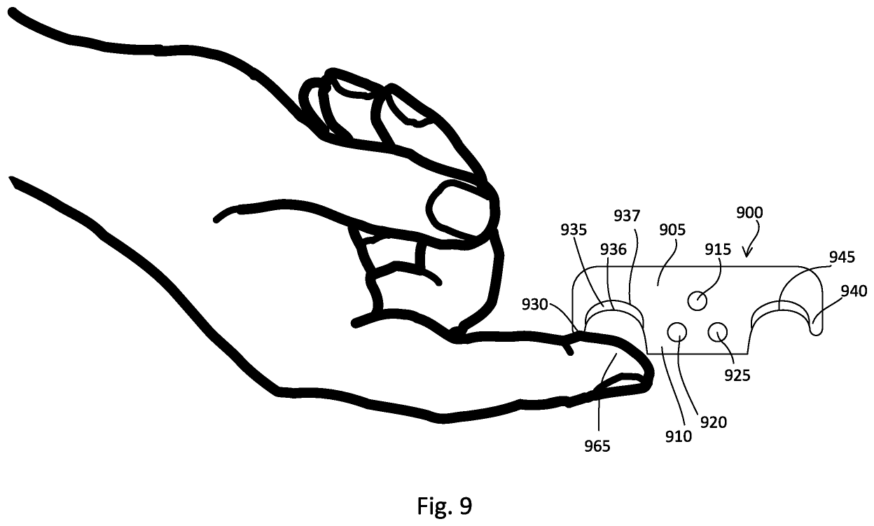

Turning to FIG. 9, a safety utility blade 900 is depicted proximate a human finger 965. The safety utility blade 900 may be similar to the safety utility blade 800 of FIGS. 8A and 8B having a first sharpened portion 935 defining a first shoulder 937 and a first cutting edge 936. As can be seen in FIG. 9, a first blade shield 930 may cooperate with the blade attachment portion 910 to limit access of the human finger 965 to the first cutting edge 936. Similarly, the second blade shield 940 may cooperate with the blade attachment portion 910 to limit access to the second sharpened portion 945. In either event, the safety utility blade 900 may be configured to limit access to associated cutting edges while the safety utility blade is being removed from an associated package, being inserted in a corresponding safety utility knife assembly (e.g., safety utility knife assembly 700 of FIG. 7), when being removed from a corresponding safety utility knife assembly and while being used within a corresponding safety utility knife assembly. The safety utility blade 900 may have a body portion 905 constructed similar to the body portion 105. The safety utility blade 900 may include blade securing holes 915, 920, 925 for securing the safety utility blade 900 to a corresponding safety cutting head (e.g., either safety cutting head 1200a or 1200b of FIGS. 12A and 12B, respectively) or securing the safety utility blade to a handle (e.g., a handle 1385 of FIG. 13).

With reference now to FIGS. 10A-10D, a method 1000d of manufacturing a safety utility blade (e.g., safety utility blade 800 of FIG. 8) is described. A strip of blade material 1000a is provided (block 1070d). The individual rough blade shapes 1001a may remain attached to one another while each of the individual steps 1075d-1085d are performed. A rough blade shape 1001a is formed in the strip of blade material 1000a (block 1075d) by removing material 1002a, 1003a, 1002b, 1003b. The material 1002a, 1003a, 1002b, 1003b may be removed from the strip of blade material 1000a by laser cutting, machining, water jet cutting, stamp shearing or any other suitable technique. The material 1002c, 1003c, 1002d, 1003d, 1002e, 1003e may be removed prior to steps 1080d, 1085d being performed or the steps 1080d, 1085d may be performed on each rough blade shape 1001a prior to removing the material 1002c, 1003c, 1002d, 1003d, 1002e, 1003e associated with the next rough blade shape 1001a. An edge (e.g., edge 811 and/or 812 of FIG. 8) of the blade attachment portion 1010b may form an angle 1046b with respect to a blade bottom edge (e.g., bottom 809 of FIG. 8) of approximately 21.2° to encourage material to be cut to move toward the blade end 1047b. The angle 1046b may be between approximately 15° and approximately 25°. As can be seen in FIG. 10A, each rough blade shape 1001a may include a blade body portion 1005a, 1005b, 1005c, 1005d and a blade attachment portion 1010a, 1010b, 1010c, 1010d. Blade securing holes 1015c, 1020c, 1025c, 1015d, 1020d, 1025d may be formed in each rough blade shape 1001a (block 1080d). The blade securing holes 1015c, 1020c, 1025c, 1015d, 1020d, 1025d may be formed by any suitable method, such as laser cutting, water jet cutting, machining, drilling, stamp shearing, etc.

With further reference to FIGS. 10A-10D, a first blade cutting edge 1035d and a second blade cutting edge 1045d may be formed in each rough blade shape 1001a (block 1085d). The first blade cutting edge 1035d may be formed prior to the second blade cutting edge 1045d or the first blade cutting edge 1035d and the second blade cutting edge 1045d may be formed simultaneously. The first blade cutting edge 1035d and the second blade cutting edge 1045d may be formed using a blade edge grinding and honing drum 1085b, a blade edge grinding and honing wheel 1085c or any other suitable method. The blade edge grinding and honing drum 1085b may have a radius 1086b that is substantially the same as the desired cutting edge radius 1004a. The blade edge grinding and honing drum 1085b may include a grinding surface 1087b of any desired roughness and hardness to form the sharpened surface portion (e.g., sharpened surface portion 1035d, 1045d). As depicted in FIG. 10B, the blade edge grinding and honing drum 1085b may include a spindle 1080b for attaching the blade edge grinding and honing drum 1085b to an associated driving and actuating machine (not shown) to rotate the blade edge grinding and honing drum 1085b or move the blade edge grinding and honing drum 1085b in any combination of a x-direction 1092b, a y-direction 1090b and a z-direction 1093b relative to the strip of blade material 1000a to produce a sharpened portion 835, 845, 835b1, 835b2. Alternatively, the strip of blade material 1000a may be oriented and moved in any one of or a combination of a x-direction 1092b, a y-direction 1090b and a z-direction 1093b relative to the blade edge grinding and honing drum 1085b to produce a sharpened portion 835, 845, 835b1, 835b2. The blade edge grinding and honing drum 1085b may be rotated about a central axis 1091b to produce a grinding and honing motion of the grinding surface 1087b relative first blade cutting edge 1035d and the second blade cutting edge 1045d. The blade edge grinding and honing drum 1085b rotated into position around a pivot axis 1094b when a corresponding rough blade shape 1005c is moved into an appropriate position relative the blade edge grinding and honing drum 1085b.

Alternatively, the first blade cutting edge 1035d and the second blade cutting edge 1045d may be formed using a blade edge grinding and honing wheel 1085c or any other suitable method. The blade edge grinding and honing wheel 1085c may have a radius 1086c that is substantially the same as the desired cutting edge radius 1004a. The blade edge grinding and honing wheel 1085c may include a grinding surface 1087c of any desired roughness and hardness to form the sharpened surface portion (e.g., sharpened surface portion 1035d, 1045d). As depicted in FIG. 10C, the blade edge grinding and honing wheel 1085c may include a spindle 1080c for attaching the blade edge grinding and honing wheel 1085c to an associated driving and actuating machine (not shown) to rotate the blade edge grinding and honing wheel 1085c and/or move the blade edge grinding and honing wheel 1085c in any combination of a x-direction 1092c, a y-direction 1090c and a z-direction 1093c relative to the strip of blade material 1000a to produce a sharpened portion 835, 845, 835b1, 835b2. Alternatively, the strip of blade material 1000a may be oriented and moved in any one of or a combination of a x-direction 1092c, a y-direction 1090c and a z-direction 1093c relative to the blade edge grinding and honing wheel 1085c to produce a sharpened portion 835, 845, 835b1, 835b2. The blade edge grinding and honing wheel 1085c may be rotated about a central axis 1091c to produce a grinding and honing motion of the grinding surface 1087c relative first blade cutting edge 1035d and the second blade cutting edge 1045d. The blade edge grinding and honing wheel 1085c rotated into position around a pivot axis 1094c when a corresponding rough blade shape 1005c is moved into an appropriate position relative the blade edge grinding and honing wheel 1085c.

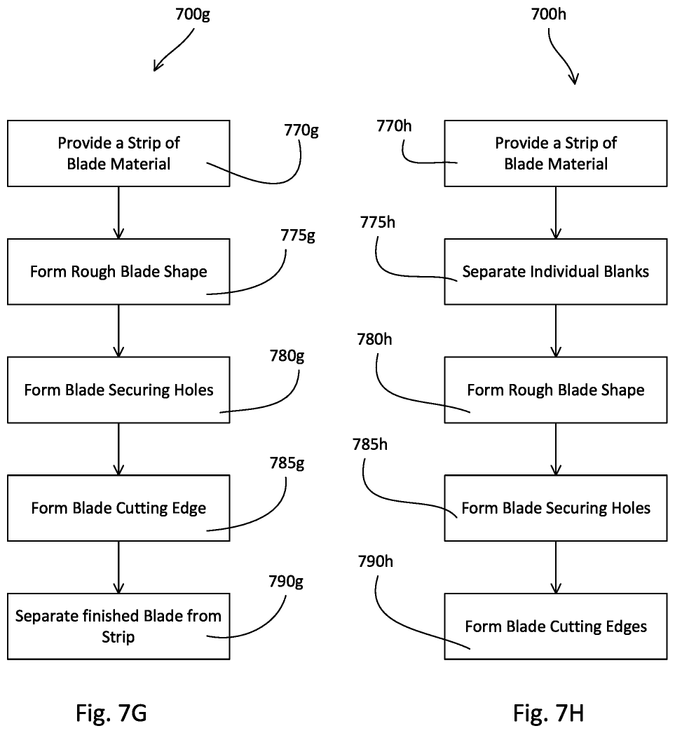

Once the blade securing holes 1015c, 1020c, 1025c and the sharpened surface portions 1035d, 1045d are formed in a respective rough blade shape 1001a, the finished safety utility blade 100 may be separated from the strip of blade material 1000a (block 1090d). Alternatively, with reference to FIGS. 10E and 11A-11D, a strip of blade material 1000a may be provided (block 1070e) and individual blade blanks 1100a may be separated from the strip of blade material 1000a (block 1075e). Rough blade shapes 1100b may be formed from the individual blade blanks 1100a by laser cutting, machining, water jet cutting, stamp shearing or any other suitable technique (block 1080e). The rough blade shapes may include a blade body portion 405a, 405b, 405c, 405d and a blade attachment portion 410a, 410b, 410c, 410d. Blade securing holes 415c, 420c, 425c, 415d, 420d, 425d may be formed in the rough blade shapes by any suitable method, such as laser cutting, water jet cutting, machining, drilling, stamp shearing, etc. (block 1085e).

With further reference to FIGS. 10E and 11A-11D, a first blade cutting edge 1135d and a second blade cutting edge 1145d may be formed in each rough blade shape 1100a (block 1090d). The first blade cutting edge 1135d may be formed prior to the second blade cutting edge 1145d or the first blade cutting edge 1135d and the second blade cutting edge 1145d may be formed simultaneously. The first blade cutting edge 1135d and the second blade cutting edge 1145d may be formed using a blade edge grinding and honing drum 385b, a blade edge grinding and honing wheel 385c or any other suitable method. The blade edge grinding and honing drum 385b may have a radius 386b that is substantially the same as the desired cutting edge radius 1004a. The blade edge grinding and honing drum 1085b may include a grinding surface 1087b of any desired roughness and hardness to form the sharpened surface portion (e.g., sharpened surface portion 1135d, 1145d). As depicted in FIG. 10B, the blade edge grinding and honing drum 1085b may include a spindle 1080b for attaching the blade edge grinding and honing drum 1085b to an associated driving and actuating machine (not shown) to rotate the blade edge grinding and honing drum 1085b or move the blade edge grinding and honing drum 1085b in any combination of a x-direction 1092b, a y-direction 1090b and a z-direction 1093b relative to the rough blade shape 1100b. Alternatively, the rough blade shape 1100b may be oriented and moved in any one of or a combination of a x-direction 1092b, a y-direction 1090b and a z-direction 1093b relative to the blade edge grinding and honing drum 1085b.

Alternatively, the first blade cutting edge 1135d and the second blade cutting edge 1145d may be formed using a blade edge grinding and honing wheel 1085c or any other suitable method. The blade edge grinding and honing wheel 1085c may have a radius 1086c that is substantially the same as the desired cutting edge radius 1004a. The blade edge grinding and honing wheel 1085c may include a grinding surface 1087c of any desired roughness and hardness to form the sharpened surface portion (e.g., sharpened surface portion 1135d, 1145d). As depicted in FIG. 3C, the blade edge grinding and honing wheel 385c may include a spindle 380c for attaching the blade edge grinding and honing wheel 385c to an associated driving and actuating machine (not shown) to rotate the blade edge grinding and honing wheel 385c and/or move the blade edge grinding and honing wheel 385c in any combination of a x-direction 392c, a y-direction 1090c and a z-direction 1093c relative to the rough blade shape 1100b. Alternatively, the rough blade shape 1100b may be oriented and moved in any one of or a combination of a x-direction 31092c, a y-direction 390c and a z-direction 1093c relative to the blade edge grinding and honing wheel 1085c.

Whether the safety utility blade 800 is completed prior to separating the rough blade shapes 1001a from the strip of blade material 1000a or the safety utility blade 800 is completed after the individual blade blanks 1100a are separated from a strip of blade material 1000a, a series of grinding and honing drums 1085b and/or grinding and honing wheels 1085c may be used to form the sharpened surface portion 1035d, 1045d, 1135d, 1145d. Each grinding and honing drum 1085b and/or grinding and honing wheel 1085c in a series of grinding and honing drums 1085b and/or grinding and honing wheels 1085c may have a progressively finer and finer grinding and honing surface 1087b, 1087c relative to the preceding grinding and honing drum 1085b and/or grinding and honing wheel 1085c in the series.

Turning to FIG. 12A, a safety cutting head 1200a is depicted including a safety utility blade 1201a attached to a handle adaptor 1270a. The safety utility blade 1201a may include a blade body portion 1205a, an blade attachment portion 1210a, blade securing holes 1215a, 1220a, 1225a, a first sharpened portion 1235a, a first blade shield 1230a, a second sharpened portion 1245a and a second blade shield 1240a. The handle adaptor 1270a may include a body portion 1265a having a first side 1271a and a second side 1272a. As depicted in FIG. 12A, the width of the body portion 1265a may be substantially equal the width of the blade attachment portion 1210a. As also depicted in FIG. 12A, the body portion 1265a may extend beyond the blade body portion 1205a. The extension of the body portion 1265a may cooperate with the securing holes 1215a, 1220a, 1225a to secure the safety utility blade 1201a to the handle adaptor 1270a. For example, the handle adaptor may be made of a thermal plastic material and may be co-molded around the safety utility blade 1201a such that the thermal plastic material penetrates through the blade securing holes 1215a, 1220a, 1225a and form a mirror half of the body portion 1265a on either side of the safety utility blade 1201a to encapsulate the blade body portion 1205a of the safety utility blade 1201a. The handle adaptor 1270a may include a handle engagement portion 1275a with a handle securing mechanism 1280a to secure the safety cutting head 1200a to a corresponding handle (e.g., handle 1385 of FIG. 13).

Turning to FIG. 12B, a safety cutting head 1200b is depicted including a safety utility blade 1201b attached to a handle adaptor 1270b. The safety utility blade 1201b may include a blade body portion 1205b, an blade attachment portion 1210b, blade securing holes 1215b, 1220b, 1225b, a first sharpened portion 1235b, a first blade shield 1230b, a second sharpened portion 1245b and a second blade shield 1240b. The handle adaptor 1270b may include a body portion 1265a having a first side 1271b and a second side 1272b. As depicted in FIG. 12A, the width of the body portion 1265b may be substantially equal the width of the blade attachment portion 1210b. The body portion 1265b may cooperate with the securing holes 1215b, 1220b, 1225b to secure the safety utility blade 1201b to the handle adaptor 1270b. For example, the handle adaptor may be made of a thermal plastic material and may be co-molded around the safety utility blade 1201b such that the thermal plastic material penetrates through the blade securing holes 1215b, 1220b, 1225b and form a mirror half of the body portion 1265b on either side of the safety utility blade 1201b to encapsulate the blade body portion 1205b of the safety utility blade 1201b. The handle adaptor 1270b may include a handle engagement portion 1275b with a handle securing mechanism 1280b to secure the safety cutting head 1200b to a corresponding handle (e.g., handle 1385 of FIG. 13). A first side 127 lb and a second side 1272b of a handle adaptor 1270b may cooperate with a body portion 1265b to form a “clamshell” and fasteners, such as metal pins, may be included to cooperate with the securing holes 1215b, 1220b, 1225b to secure a replaceable safety utility blade 100 within a safety cutting head 1200b. When a clamshell structure is provided, a handle engagement portion 1275b may be configured with two halves with each halve being fixed to a respective side 1271b, 1272b of the handle adaptor 1270b. When a safety utility blade 800 is placed within a clamshell structure and the clamshell structure is engaged with a handle 1385, the safety utility blade 800 is secured within the clamshell structure of the safety cutting head 1200b. The body portion 1265b may be configured as a hinge mechanism within a clamshell structure and fasteners, such as metal pins, may be fixed to a respective side 1271b, 1272b of the handle adaptor 1270b.

Turning to FIG. 13, a safety cutting head 1301 is depicted proximate an associated handle 1385. The safety cutting head 1301 may include a first body side 1302 and a second body side 1303. The safety cutting head 1301 may include a handle engagement 1375 having a handle securing mechanism 1380. The handle 1385 may include a cutting head engagement 1390 having a cutting head securing mechanism 1395.

The safety utility knife assembly 1300 may include a handle 1385 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 1300 may include a first body side 1302, a second body side 1303, and a handle engagement 1375 having a handle securing mechanism 1380 injection molded of a nylon (e.g., polycaprolactam/Nylon (PA6), Nylon 66, etc.) with a second antimicrobial material (e.g., a BioCote® silver ion material) incorporated within the nylon. Additionally, or alternatively, the handle 1385, the first body side 1302, the second body side 1303 and/or the handle engagement 1375 having a handle securing mechanism 1380 may include an overmold (e.g., thermoplastic elastomer (TPE)) with a third antimicrobial material (e.g., a BioCote®, SANAFOR® PO-5, SANAFOR® EBA-10, or SANAFOR® PS-10). The replaceable safety utility knife assembly 1300 may include a blade made from an antimicrobial material (e.g., stainless steel), or may be made, for example, from carbon steel and include an antimicrobial coating (e.g., silver, silver ion, copper, zinc, etc.). Additionally, any one of, or all of, the handle 1385, the first body side 1302, the second body side 1303 and/or the handle engagement 1375 may include a metallic material embedded in the associated plastic material.

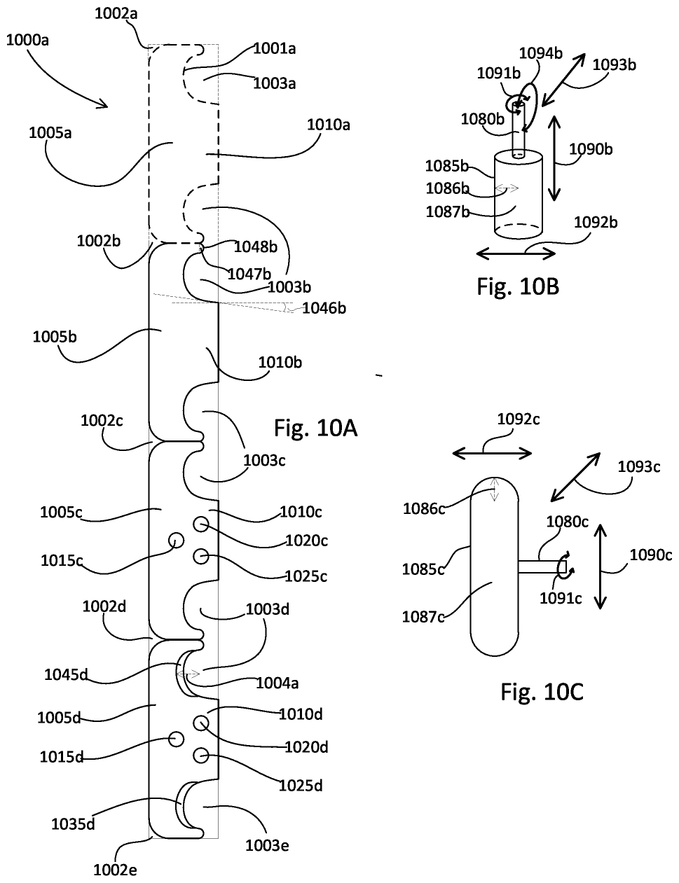

With reference now to FIG. 14, a safety utility knife assembly 1400 is depicted including a safety cutting head 1401 and a handle 1485. The safety cutting head 1401 may include a first side 1402 that aligns with a first handle side 1476 and a second side 1403 that aligns with a second handle side 1477 when the handle engagement 1475 is secured to the cutting head engagement 1490 via the handle securing mechanism 1480 and the cutting head securing mechanism 1495. A safety utility knife assembly 1400 may be configured to store one or more additional safety cutting heads 1401. For example, a second safety cutting head 1401 may be secured to each end of the handle 1485. Alternatively, the handle 1485 may include a spare safety cutting head 1401 retaining mechanism.

The safety utility knife assembly 1400 may include a handle 1485 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 1400 may include a first body side 1402, a second body side 1403, and a handle engagement 1475 having a handle securing mechanism 1480 injection molded of a nylon (e.g., polycaprolactam/Nylon (PA6), Nylon 66, etc.) with a second antimicrobial material (e.g., a BioCote® silver ion material) incorporated within the nylon. Additionally, or alternatively, the handle 1485, the first body side 1402, the second body side 1403 and/or the handle engagement 1475 having a handle securing mechanism 1480 may include an overmold (e.g., thermoplastic elastomer (TPE)) with a third antimicrobial material (e.g., a BioCote®, SANAFOR® PO-5, SANAFOR® EBA-10, or SANAFOR® PS-10). The replaceable safety utility knife assembly 1400 may include a blade made from an antimicrobial material (e.g., stainless steel), or may be made, for example, from carbon steel and include an antimicrobial coating (e.g., silver, silver ion, copper, zinc, etc.). Additionally, any one of, or all of, the handle 1485, the first body side 1402, the second body side 1403 and/or the handle engagement 1475 may include a metallic material embedded in the associated plastic material.

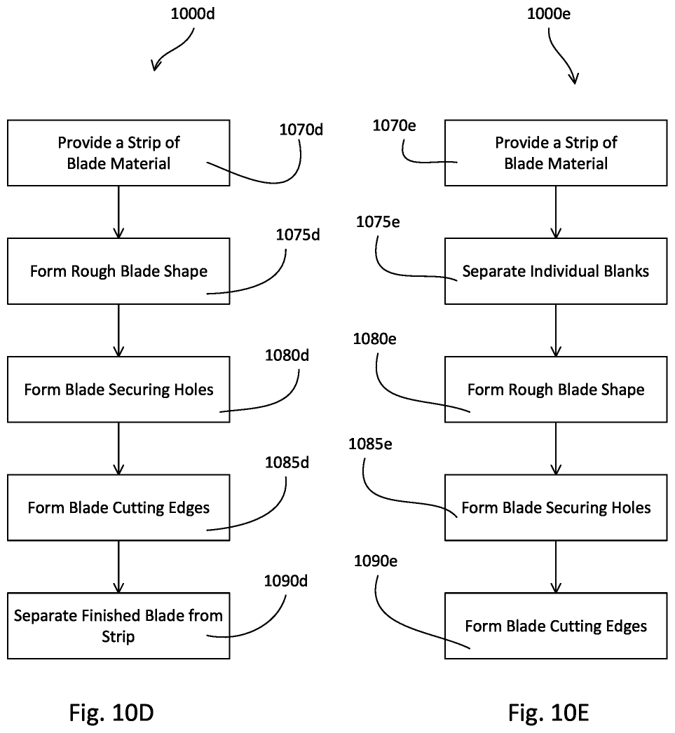

Turning now to FIGS. 15A-15H and 15J-15K, a safety utility knife assembly 1500a, 1500b, 1500c, 1500d, 1500e, 1500f, 1500g, 1500h, 1500j, 1500k is depicted including a blade 1510a, 1510b, 1510c, 1510e, 1510f, 1510g, 1510k within a blade holder 1505a, 1505b, 1505c, 1505d, 1505e, 1505f, 1505g, 1505j, 1505j, 1505k inserted in a handle 1515a, 1515b, 1515c, 1515d, 1515e, 1515f, 1515g, 1515h, 1515j, 1515k. The blade holder 1505a, 1505b, 1505c, 1505d, 1505e, 1505f, 1505g, 1505j, 1505j, 1505k may include a handle engagement 1506b, 1506d, 1506e, 1506f, 1506g, 1506j a blade retaining offset 1508e and blade retainer 1507d, 1507e. The handle 1515a, 1515b, 1515c, 1515d, 1515e may include a blade holder engagement 1516b, 1516e, 1516f that cooperates with the handle engagement 1506b, 1506d, 1506e, 1506g, 1506j to secure the blade holder 1505a, 1505b, 1505c, 1505d, 1505e, 1505f, 1505g, 1505j, 1505j, 1505k within the handle 1515a, 1515b, 1515c, 1515d, 1515e, 1515f, 1515g, 1515h, 1515j, 1515k. The blade retaining offset 1508e, a first blade retainer 1507d, 1507e, 1507f, a second blade retainer 1508f and a third blade retainer 1509f cooperate with the handle 1515a, 1515b, 1515c, 1515d, 1515e to secure the blade edge 1512c, 1512f proximate a blade retaining offset surface 1511c, 1511f. The safety utility knife assembly 1500a, 1500b, 1500c, 1500d, 1500e, 1500f, 1500g, 1500h, 1500j, 1500k may include a spare blade compartment to store unused blades 1510a, 1510b, 1510c, 1510e, 1510f, 1510g, 1510k.

With additional reference to FIG. 15B, a lock 1516b1 may be provided, for example, for safety knife assemblies 1500b for use in food service industries where companies want users to remove the associated blade outside of production areas. The lock 1516b1 may be located over top of the button 1506b in a shape of, for example, a “dog house” that covers the opening where the tab 1506b is pushed down for release of the blade holder. A mating release key (not shown in the Figures) may be provide which may, for example, enter from an end 1517b of the handle and presses the tab 1516b down, which may release the blade holder portion for blade replacement. Alternatively, or additionally, a mating release key may be provided that may be inserted into the lock 1516b1 to engage the tab 1516b.

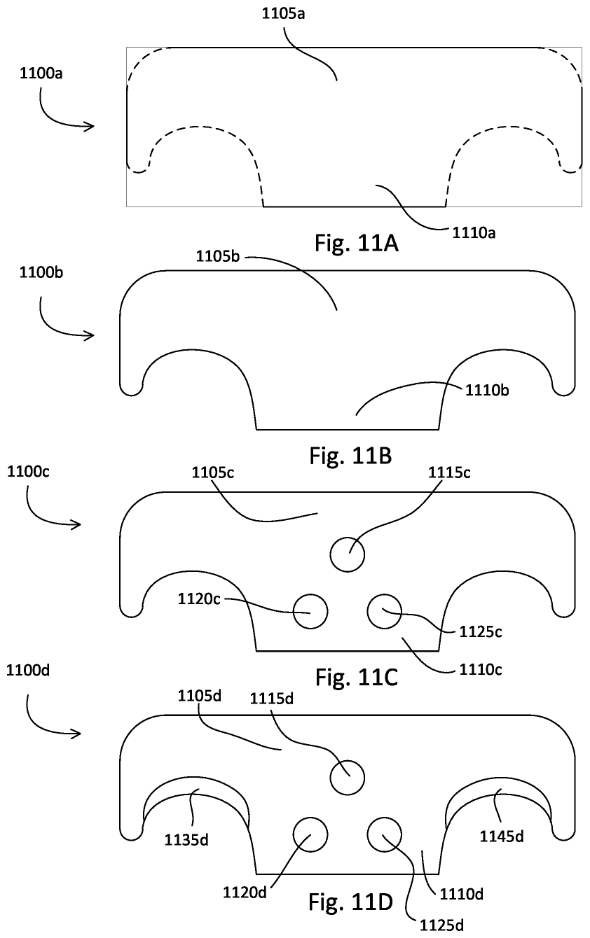

With reference to FIGS. 16A-16H and 16J a blade holder 1605a, 1605b, 1605c, 1605d, 1605e, 1605f, 1605g, 1605h, 1605j is depicted including a blade edge 1612b, 1612e, 1612f of blade 1610a, 1610b, 1610c, 1610d, 1610e, 1610f, 1610g, 1610h, 1610j secured against a blade retaining offset surface 1611b, 1611e, 1611f of the blade holder 1605a, 1605b, 1605c, 1605d, 1605e, 1605f, 1605g, 1605h, 1605j by a first blade retainer 1607a, 1607b, 1607c, 1607e, 1607j, a second blade retainer 1608a, 1608b, 1608c, 1608e, 1608j and a third blade retainer 1609a, 1609b, 1609c, 1609e, 1609j. A blade holder head 1620a, 1620b, 1620c, 1620d, 1620e, d20f, 1620g, 1620h, 1620j and blade shield 1625a, 1625b, 1625f, 1625j are offset from the blade holder 1605a, 1605b, 1605c, 1605d, 1605e, 1605f, 1605g, 1605h, 1605j at offset surface 1621a, 1621b, 1621c, 1621e, 1621f, 1621g, 1621j by a distance substantially equal to a thickness (e.g., thickness 806b of FIG. 8B) of the blade 1610a, 1610b, 1610c, 1610d, 1610e, 1610f, 1610g, 1610h, 1610j. The blade holder 1605a, 1605b, 1605c, 1605d, 1605e, 1605f, 1605g, 1605h, 1605j may include a first slide 1622a, 1622b, 1622c, 1622e, 1622f and a second slide 1623a, 1623b, 1623e, 1623f that are received within a corresponding handle 1515a, 1515b, 1515c, 1515d, 1515e, 1515f, 1515g, 1515h, 1515j, 1515k and secured within the handle 1515a, 1515b, 1515c, 1515d, 1515e, 1515f, 1515g, 1515h, 1515j, 1515k with handle engagement mechanism 1606a, 1606b, 1606c, 1606d, 1606e, 1606f with biasing member 1624a, 1624b, 1624c, 1624e, 1624f. As depicted in FIG. 16F, a blade throat 1630f defines an angle 1635f with respect to a longitudinal axis of the blade holder 1605f of approximately 38°. The angle 1635f may be between approximately 30° and approximately 45°. The blade throat 1630f may define an angle 1635f with respect to a longitudinal axis of the blade holder 1605f between 25° and 50°. The blade throat 1630f may be approximately 0.188 inches, thereby, the blade throat 1630f limits exposure to the cutting edge of the blade 1610f. The cutting edge of the blade 1610f may define an angle (e.g., angle 1513c of FIG. 15C) with respect to a longitudinal axis of the blade holder 1605f of approximately 20°. The cutting edge of the blade 1610f may define an angle 1513c with respect to a longitudinal axis of the blade holder 1605f between 15° and 25°.

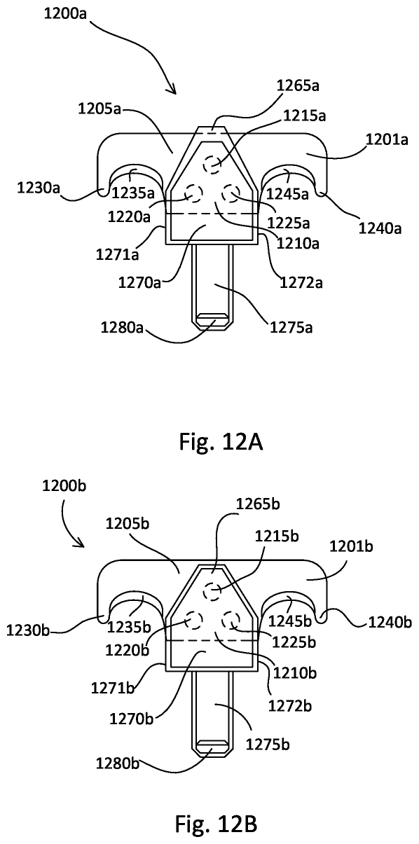

Turning to FIGS. 17A and 17E, a method 1700e of manufacturing a blade 1710a3 for use in a safety utility knife assembly (e.g., safety utility knife assembly 1500a of FIG. 15A) may include providing a strip of blade material 1700a (block 1770e). A rough blade shape 1710a1 may be formed by removing material 1750a (block 1775e). Blade securing holes 1745a3, 1746a3, 1747a3 may be formed in the rough blade shape 1710a1 by any suitable method, such as laser cutting, water jet cutting, machining, drilling, stamp shearing, etc. (block 1780e). A sharpened portion 1740a2, 1740a3 may be formed by any suitable method, such as those disclosed in U.S. Pat. Nos. 4,265,055, 5,842,387, 6,860,796 or 8,206,199, for example (block 1785e). The sharpened portion 1740a2, 1740a3 may define a shoulder 1741a2, 1741a3 and a cutting edge 1742a2, 1742a3. The blade 1710a3 may be separated from the strip of blade material 1700a by removing material 1752a, 1753a (block 1790e). A blade end 1751a may form an angle 1713a with respect to a linear edge of the strip of blade material 1700a of approximately 60°. The angle 1713a may be between approximately 55° and approximately 70°.

With reference now to FIGS. 17B-17D and 17F, a method 1700f of manufacturing a blade 1710d for use in a safety utility knife assembly (e.g. safety utility knife assembly 800a of FIG. 8A) may include providing a strip of blade material 1700a (block 1770f). Blade blanks 1700b may be formed from the strip of blade material 1700a (block 1775f). Rough blade shapes 1707b may be formed from the blade blanks 1700b (block 1780f). Blade securing holes 1745b, 1746b, 1747b may be formed in the rough blade shape 1700b by any suitable method, such as laser cutting, water jet cutting, machining, drilling, stamp shearing, etc. (block 1785f). A sharpened portion 1740c, 1740d may be formed by any suitable method, such as those disclosed in U.S. Pat. Nos. 4,265,055, 5,842,387, 6,860,796 or 8,206,199, for example (block 1790f). The sharpened portion 1740c, 1740d may define a shoulder 1741c, 1741d and a cutting edge 1742c, 1742c.

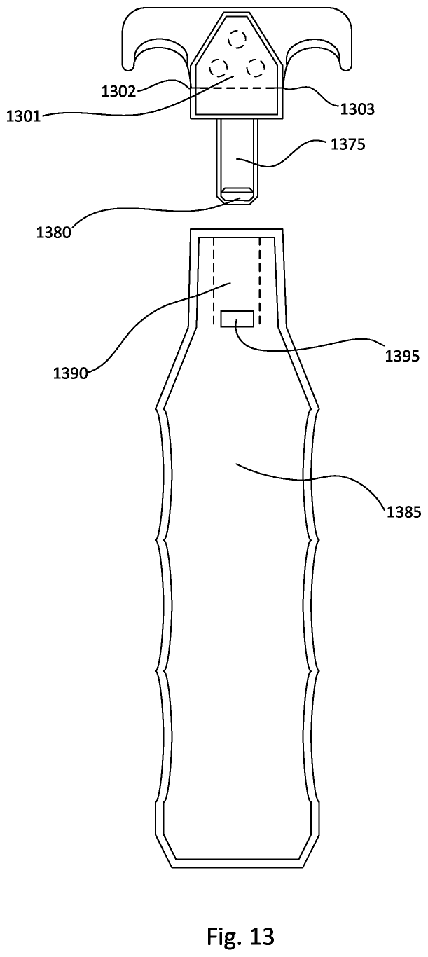

With reference to FIG. 18, a safety utility blade 1810 for use in the safety utility knife assembly 1500a of FIG. 15A may have a body 1810a formed from a relatively thin and substantially flat material 1000a, such as ceramic, heat treated carbon steel, ceramic coated steel, stainless steel, Teflon coated material, etc. For example, the material 1000a may be approximately 0.025 inches thick. A blade blank (e.g. blade blank 1000a, 1000b of FIGS. 10A and 10B, respectively) may be 1.0964567 inches from a first end 1050a to a second end 1051a and 0.3917323 inches from a top side 1010c to a bottom side 1042d. The safety utility blade may include blade securing holes 1815, 1820, 1825. As described herein the blade securing holes 1815, 1820, 1825 may, at least in part, secure a safety utility blade 1810 to a safety utility knife cutting head (e.g., safety utility knife cutting head 1620j of FIG. 16J). The safety utility blade 1810 may be formed from a suitable material 1000a for retaining a sharpened edge 1836, 1837, and, when that material 1700a is metal, the body 1810a preferably has a thickness 806b of at least 0.0156 inches and preferably not greater than about 0.0313 inches. What might be characterized as a “heavy-duty” safety utility blade 800 is approximately 0.025 inches thick, and the thickness 806b for what might be characterized as a “regular duty” safety utility blade 1810 is approximately 0.017 inches. The sharpened portion 1835, 1845 is approximately 0.0492 inches high.

With further reference to FIG. 18, the first sharpened portion 1835 of the safety utility blade 1810 may include a first shoulder 1837, a first cutting edge 1836, a first heal 1839 and a first toe 1838. The safety utility blade may include a first edge 1811 extending from the first heal 1839 to the bottom side. The safety utility blade 1810 may further include a first inner edge 1833 that extends from the first toe 1839 to the bottom side and may have a thickness that is greater than the first sharpened portion 1835 and less than or equal to the thickness 176b of the body 1705a. The first edge 1818 and the first inner edge 1833 may cooperate to limit access to the cutting edge 1836 while the safety utility blade 1810 is being used in the safety utility knife assembly 1500a, while the safety utility blade 1810 is being inserted into the safety utility knife assembly 1500a, while the safety utility blade 1810 is being removed from the safety utility knife assembly 1500a and while the safety utility blade 1810 is being handled while removed from the safety utility knife assembly 1500a.

With further reference to FIG. 18, the safety utility blade 1810 may include a second sharpened portion 1845 which may include a second shoulder 1847, a second cutting edge 1846, a second heal 1849 and a second toe 1848. The safety utility blade 1810, 810b may include a second edge 1812 extending from the second heal 1849 to the bottom side. The safety utility blade 1810 may further include a second inner edge 1843 that extends from the second toe 1849 to the bottom side and may have a thickness that is greater than the second sharpened portion 1845 and less than or equal to the thickness 806b of the body 1705a. As depicted in FIG. 8B, the cutting edge 836b may be defined by a third sharpened portion 835b1 extending from a third shoulder 837b1 and a fourth sharpened portion 835b2 extending from a fourth shoulder 837b2. It should be understood that either of the cutting edges 1836, 1846 may be formed similar to cutting edge 836b. The second edge 1812 and the second inner edge 1843 may cooperate to limit access to the cutting edge 1846 while the safety utility blade 1810 is being used in the safety utility knife assembly 1500a, while the safety utility blade 1810 is being inserted into the safety utility knife assembly 1500a, while the safety utility blade 1810 is being removed from the safety utility knife assembly 1500a and while the safety utility blade 1810 is being handled while removed from the safety utility knife assembly 1500a. A safety utility blade 1810 may be manufactured similar to the safety utility blade 800 as described with reference to FIGS. 10A-10E and 11A-11D.

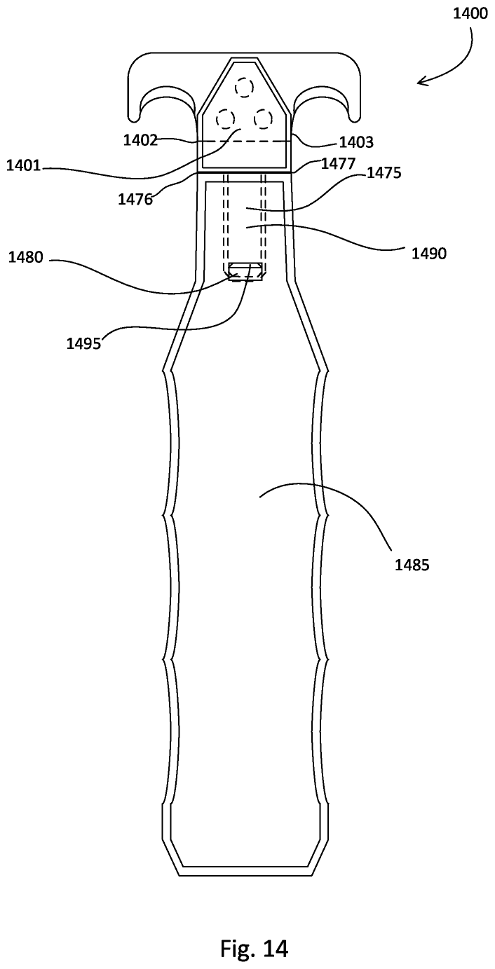

Turning to FIGS. 19A-D, a safety utility knife assembly 1900a-d may include a blade carrier 1915a-d. The safety utility knife assembly 1900a-d may be similar to, for example, any one of the safety utility knife assemblies described elsewhere herein. However, the safety utility knife assembly 1900a-d is particularly useful for applications associated with food processing industries. In particular, the safety utility knife assembly 1900a-d may include components that are made of metallic materials that are detectable via standard metal detection equipment as commonly used in food processing. Thereby, if a safety utility knife assembly 1900a-d, and/or any component(s) thereof (e.g., a blade carrier 1915a-d or a safety utility blade 1925c,d), are, for example, dropped into associated food processing equipment, the safety utility knife assembly 1900a-d, and/or any component(s) thereof (e.g., a blade carrier 1915a-d or a safety utility blade 1925c,d), may be detected by the metal detection equipment. Subsequent to detection, the safety utility knife assembly 1900a-d, and/or any component(s) thereof (e.g., a blade carrier 1915a-d or a safety utility blade 1925c,d), may be, for example, automatically retrieved via, for example, a magnetic device.

In order to decrease the likelihood that the safety utility blade 1925c,d and/or the blade carrier 1915a-d will become separated from the handle 1905d, the safety utility knife assembly 1900a-d may include at least one of: a blade tip receptacle 1932b-d and a redundant blade carrier locking mechanism 1908d1, 1908d2, 1909d1. The blade tip receptacle 1932b-d may be formed by, for example, bending a blade carrier blank extension 1932a such that the blade carrier blank extension 1932a overlaps a blade carrier blank portion 1931a-d (i.e., the blade tip receptacle 1932b-d is defined between the blade carrier blank extension 1932a and the blade carrier blank portion 1931a-d). Accordingly, when a safety utility blade 1925c,d is slid within (i.e., underneath and in between) the blade retainers 1942a-c, 1943a-c, a tip of the safety utility blade 1925c,d is received within the blade tip receptacle 1932b-d, and the blade carrier 1915a-d is inserted within the handle 1905d, the safety utility blade 1925c,d is secured within the safety utility knife assembly 1900a-d. While the safety utility blade 1925c,d is illustrated within FIGS. 19C and 19D as a reversible hook blade, the safety utility blade 1925c,d may be, for example, as shown in FIGS. 17C, 17D or 18.

When the blade carrier blank extension 1932a is folded to overlap the blade carrier blank portion 1931a-d, the tab 1933a-d may be secured to the blade carrier 1915a-d via, for example, spot welding. Alternatively, or additionally, when the blade carrier blank extension 1932a is folded to overlap the blade carrier blank portion 1931a-d,the tab 1933a-d may be received within a receptacle 1934a-d and the tab 1933a-d and/or the receptacle 1934a-d may be crimped to secure the blade carrier blank extension 1932a to the blade carrier 1915a-d. In any event, when the blade carrier blank extension 1932a is folded to overlap the blade carrier blank portion 1931a-d, the blade carrier blank extension 1932a may define a blade throat that limits an exposure of a user to the safety utility blade 1925c,d. Additionally, when the blade carrier blank extension 1932a is folded to overlap the blade carrier blank portion 1931a-d, the blade carrier blank portion 1931b-d may define a hook tip. A user may employ the hook tip 1931b-d to, for example, penetrate an associated package when utilizing the safety utility blade assembly 1900a-d.

The redundant blade carrier locking mechanism 1908d1, 1908d2, 1909d1 may generally be defined by a first handle aperture 1908d, a second handle aperture 1909d, a blade carrier hook 1918a-d, and a blade carrier stop 1923a-d. The blade carrier hook 1918a-d may be formed at, for example, a distal end of a blade carrier finger pivot 1943a-d. The blade carrier stop 1923a-d may be formed at, for example, a distal end of a blade carrier tab pivot 1917a-c. The blade carrier tab pivot 1917a-c may, for example, surround the blade carrier finger pivot 1943a-d such that the blade carrier tab pivot 1917a-c and the blade carrier finger pivot 1943a-d may flex independently of one another, respectively, when a user presses on either the blade carrier hook 1918a-d or the blade carrier stop 1923a-d. The blade carrier 1915a-d may include expansion tabs 1940a-c, 1941a-c, 1942a-c configured to secure the blade carrier 1915a-d within a handle 1905d to, for example, limit lateral movement of the safety utility blade 1925c,d when the blade carrier 1915a-d and safety utility blade 1925c,d are inserted within the handle 1905d. The blade retainers 1942a-c, 1943a-c may also be configured to limit lateral movement of the safety utility blade 1925c,d when the blade carrier 1915a-d and safety utility blade 1925c,d are inserted within the handle 1905d.

In any event, when the blade carrier 1915a-d is linearly inserted within the handle 1905d, the blade carrier hook 1918a-d and the blade carrier stop 1923a-d slide along an inner surface of the handle 1905d. Once the expansion tabs 1941a-c, 1940a-c are received within the handle 1905d, the blade carrier tab pivot 1917a-c and the blade carrier finger pivot 1943a-d may flex such that the blade carrier hook 1918a-d and the blade carrier stop 1923a-d are biased laterally outward against the inner surface of the handle 1905d. Once the blade carrier stop 1923a-d reaches the aperture 1908d, the blade carrier tab pivot 1917a-c flexes such that the blade carrier stop 1923a-d moves laterally outward through the aperture 1908d and engages a rearward edge 1908d1 of the aperture 1908d, thereby, stopping further inward linear movement of the blade carrier 1915a-d into the handle 1905d. Once the blade carrier stop 1923a-d moves laterally outward through the aperture 1908d and engages the rearward edge 1908d1 of the aperture 1908d, a user may press laterally inward on the blade carrier stop 1923a-d causing the blade carrier stop 1923a-d to disengage the rearward edge 1908d1 and allow the user to further linearly insert the blade carrier 1915a-d into the handle 1905d such that the blade carrier hook 1918a-d moves laterally outward through the aperture 1908d. Once the blade carrier hook 1918a-d moves laterally outward through the aperture 1908d, the blade carrier hook 1918a-d will engage a forward edge 1908d2 of the aperture 1908d as the user moves the blade carrier 1915a-d linearly outward from the handle 1905d. Once the blade carrier hook 1918a-d fully engages the forward edge 1908d2 of the aperture 1908d, the blade carrier stop 1923a-d once again moves laterally outward through the aperture 1908d such that the blade carrier stop 1923a-d once again engages the rearward edge 1908d1.

To remove the blade carrier 1915a-d from the handle 1905d, a user may press the blade carrier stop 1923a-d laterally inward such that the blade carrier stop 1923a-d disengages the rearward edge 1908d1. The user may then move the blade carrier 1915a-d linearly inward into the handle 1905d until the blade carrier hook 1918a-d disengages the forward edge 1908d2. Once the blade carrier hook 1918a-d disengages the forward edge 1908d2, the user may press the blade carrier hook 1918a-d laterally inward and move the blade carrier 1915a-d linearly outward from the handle 1905d. Thereby, the blade carrier stop 1923a-d, the blade carrier hook 1918a-d, and the aperture 1908d may define a redundant blade carrier locking mechanism.

The safety utility knife assembly 1900a-d may be further configured such that the blade carrier hook 1918a-d may move laterally outward through the second aperture 1909d and engage the edge 1909d1 when a user further moves the blade carrier 1915a-d linearly outward from the handle 1905d. Thereby, the blade carrier hook 1918a-d and the second aperture 1909d may further define a further redundant blade carrier locking mechanism.

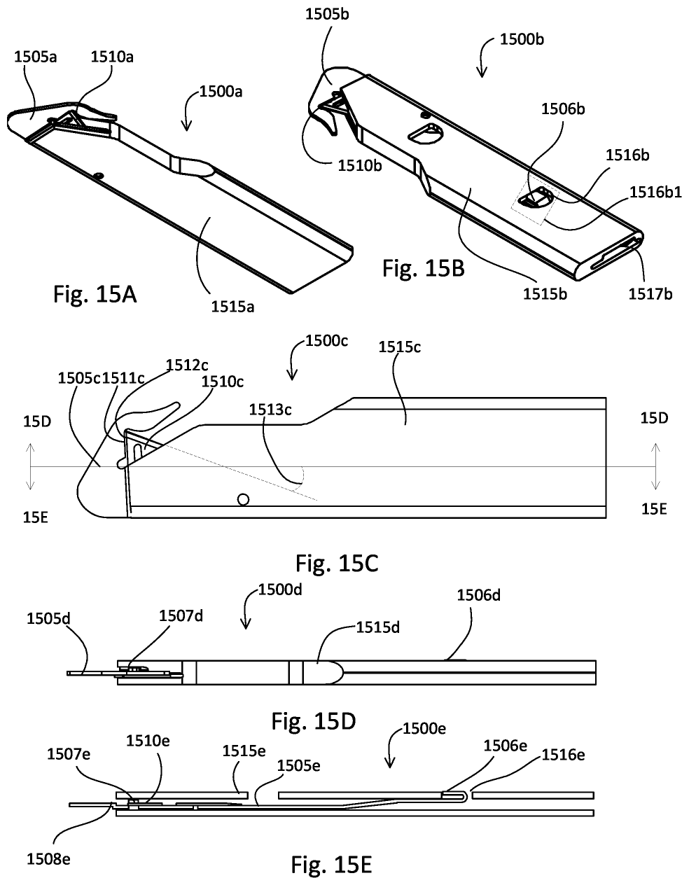

With reference to FIG. 20, a safety cutter assembly 2000 may include a handle 2005 having material pierce 2006, a lanyard attachment aperture 2007, and an over mold material 2008. The handle 2005 may be injection molded of a polypropylene copolymer (e.g., polypropylene (PP)) with a first antimicrobial material (e.g., SANAFOR® PO-5 or SANAFOR® EBA-10) incorporated within the polypropylene copolymer. Additionally, or alternatively, the handle 2005 may include an over mold (e.g., thermoplastic elastomer (TPE)) with a second antimicrobial material (e.g., a BioCote®, SANAFOR® PO-5, SANAFOR® EBA-10, or SANAFOR® PS-10). Additionally, the handle 2005 may include a metallic material embedded in the associated plastic material.

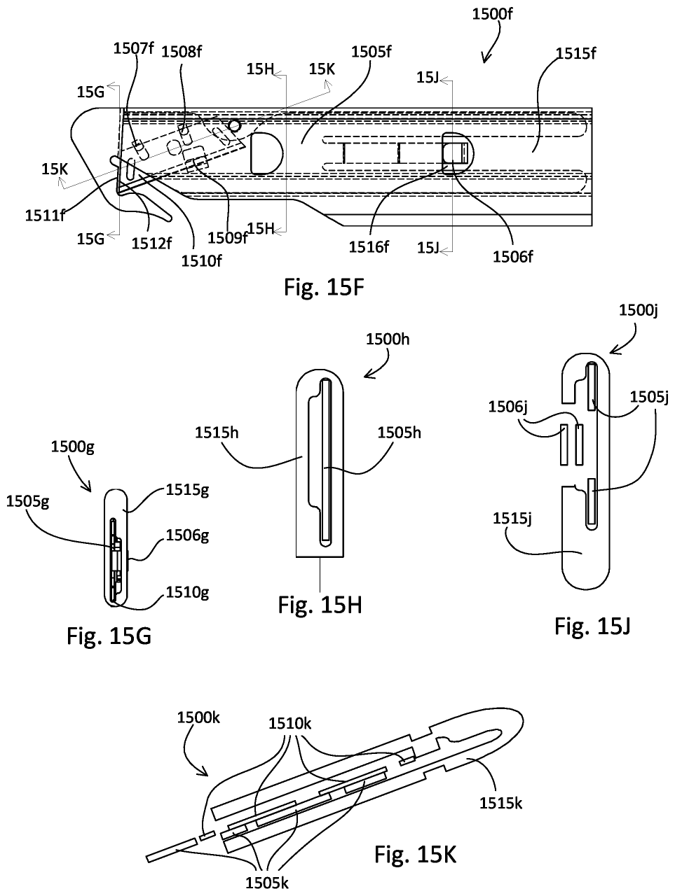

Turning to FIG. 21, a safety cutter assembly 2100 may include a handle 2105 injection molded of a polypropylene copolymer (e.g., polypropylene (PP)) with a first antimicrobial material (e.g., SANAFOR® PO-5 or SANAFOR® EBA-10) incorporated within the polypropylene copolymer. The handle 2105 may include a material pierce 2106, a lanyard attachment aperture 2107, and an over mold material 2108. The safety utility knife assembly 2100 may include a replaceable blade retainer 2115 injection molded of a nylon (e.g., polycaprolactam/Nylon (PA6), Nylon 66, etc.) with a second antimicrobial material (e.g., a BioCote® silver ion material) incorporated within the nylon. Additionally, or alternatively, the handle 2105 and/or the blade retainer 2115 may include an over mold (e.g., thermoplastic elastomer (TPE)) with a third antimicrobial material (e.g., a BioCote®, SANAFOR® PO-5, SANAFOR® EBA-10, or SANAFOR® PS-10). The blade 2125 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 2105 and/or the blade retainer 2115 may include a metallic material embedded in the associated plastic material.

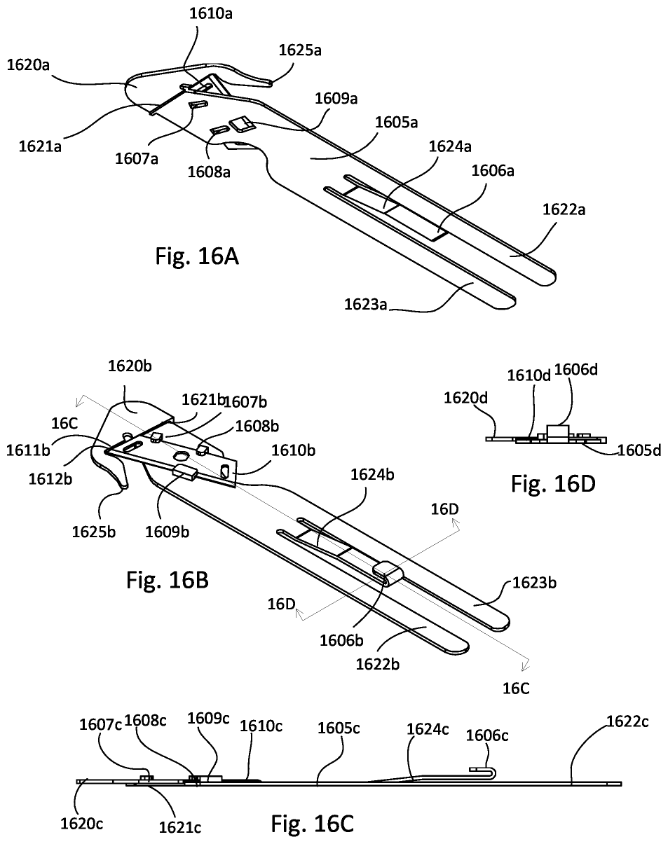

With reference to FIG. 22, a safety cutter assembly 2200 may include a handle 2205, having first and second integral blade retainers 2215 injection molded of a nylon (e.g., polycaprolactam/Nylon (PA6), Nylon 66, etc.) with a first antimicrobial material (e.g., a BioCote® silver ion material) incorporated within the nylon. The handle 2205 may include a material pierce 2206, a lanyard attachment aperture 2207, and an over mold material 2208. The over mold 2208 (e.g., thermoplastic elastomer (TPE)) may include a second antimicrobial material (e.g., a BioCote®, SANAFOR® PO-5, SANAFOR® EBA-10, or SANAFOR® PS-10). The first and second blades 2225 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 2205 and/or the first and/or second integral blade retainers 2215 may include a metallic material embedded in the associated plastic material.

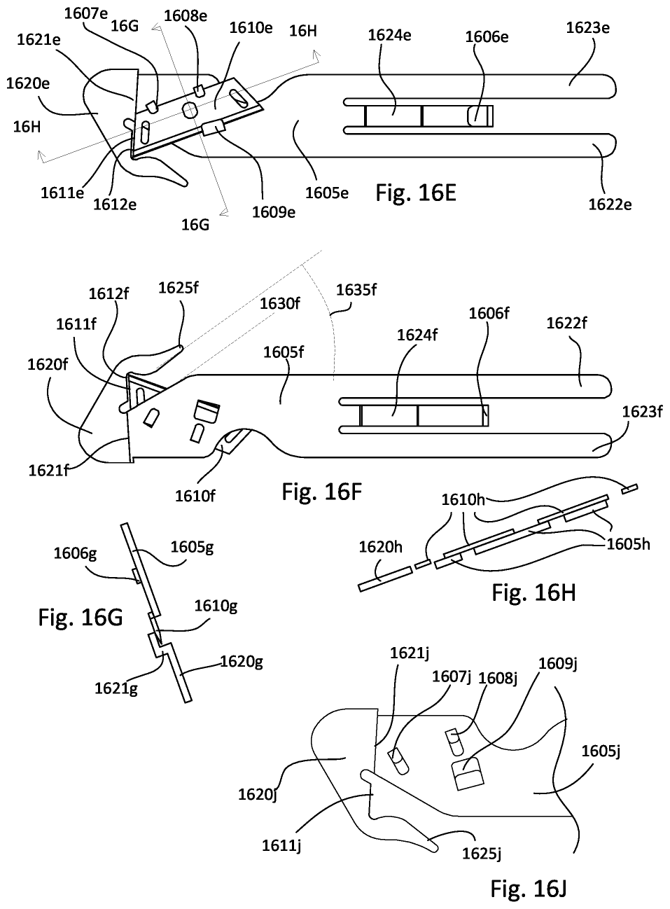

Turning to FIG. 23, a safety cutter assembly 2300 may include a handle 2305, having an integral blade retainer 2315 injection molded of a nylon (e.g., polycaprolactam/Nylon (PA6), Nylon 66, etc.) with a first antimicrobial material (e.g., a BioCote® silver ion material) incorporated within the nylon. Additionally, or alternatively, the handle 2305 and/or the integral blade retainer 2315 may include an over mold 2308 (e.g., thermoplastic elastomer (TPE)) with a second antimicrobial material (e.g., a BioCote®, SANAFOR® PO-5, SANAFOR® EBA-10, or SANAFOR® PS-10). The blade 2325 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 2305 and/or the integral blade retainer 2315 may include a metallic material embedded in the associated plastic material.

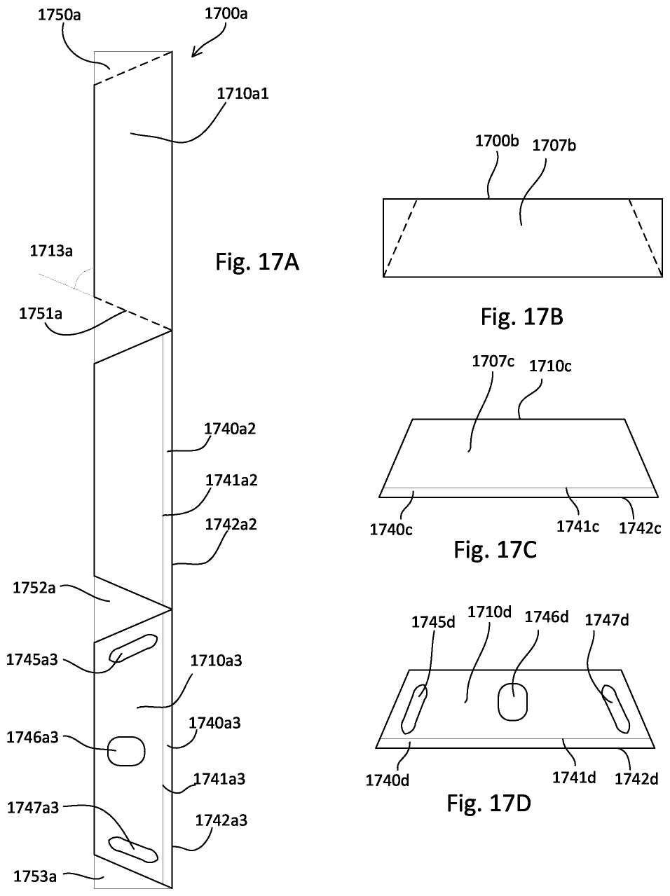

With reference to FIG. 24, a safety cutter assembly 2400 may include a handle 2405, having first and second integral blade retainers 2415 injection molded of a nylon (e.g., polycaprolactam/Nylon (PA6), Nylon 66, etc.) with a first antimicrobial material (e.g., a BioCote® silver ion material) incorporated within the nylon. The handle 2405 may include a lanyard attachment aperture 2407 and a pocket clip 2409. The first and second blades 2425 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 2405 and/or the first and/or second integral blade retainers 2415 may include a metallic material embedded in the associated plastic material.

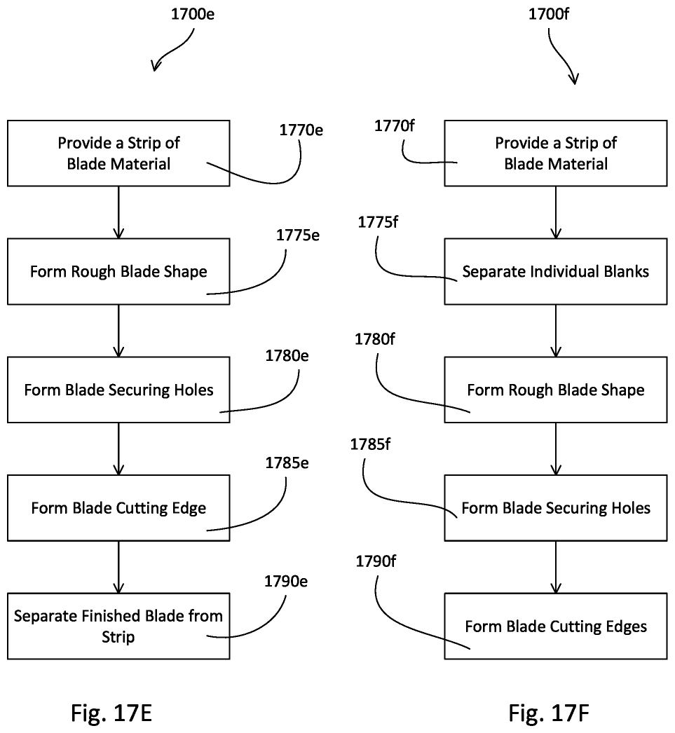

Turning to FIG. 25, a safety cutter assembly 2500 may include a handle 2505, having an integral blade retainer 2515, injection molded of a nylon (e.g., polycaprolactam/Nylon (PA6), Nylon 66, etc.) with a first antimicrobial material (e.g., a BioCote® silver ion material) incorporated within the nylon. The handle 2505 may include a material pierce 2506, a lanyard attachment aperture 2507, and a pocket clip 2509. The blade 2325 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 2505 and/or the integral blade retainer 2515 may include a metallic material embedded in the associated plastic material.

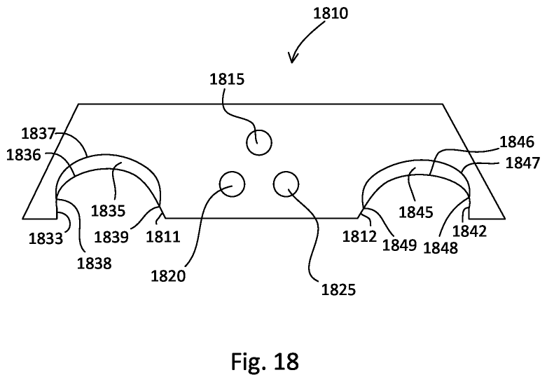

With reference to FIG. 26, a safety cutter assembly 2600 may include a handle 2605, having an integral blade retainer 2615, injection molded of a nylon (e.g., polycaprolactam/Nylon (PA6), Nylon 66, etc.) with a first antimicrobial material (e.g., a BioCote® silver ion material) incorporated within the nylon. The handle 2605 may include a lanyard attachment aperture 2607. The blade 2625 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 2605 and/or the integral blade retainer 2615 may include a metallic material embedded in the associated plastic material.

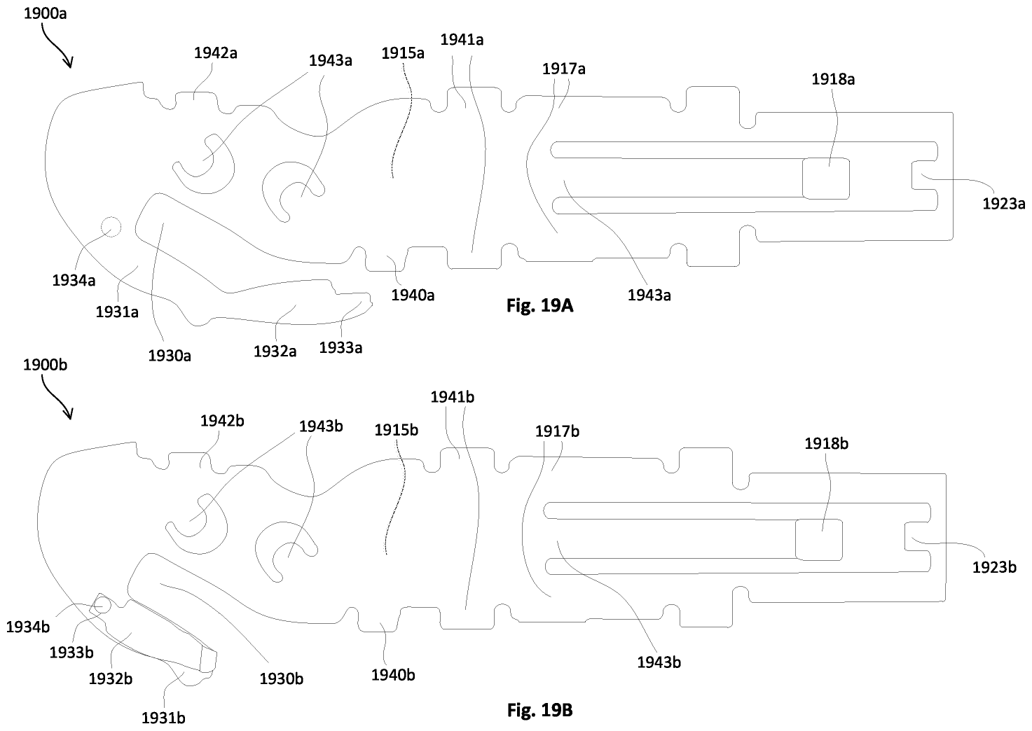

Turning to FIG. 27, a safety cutter assembly 2700 may include a handle 2705 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 2700 may include a replaceable blade retainer 2715 injection molded of a nylon (e.g., polycaprolactam/Nylon (PA6), Nylon 66, etc.) with a second antimicrobial material (e.g., a BioCote® silver ion material) incorporated within the nylon. Additionally, any one of, or each of, the handle 2705 and/or the blade retainer 2715 may include a metallic material embedded in the associated plastic material.

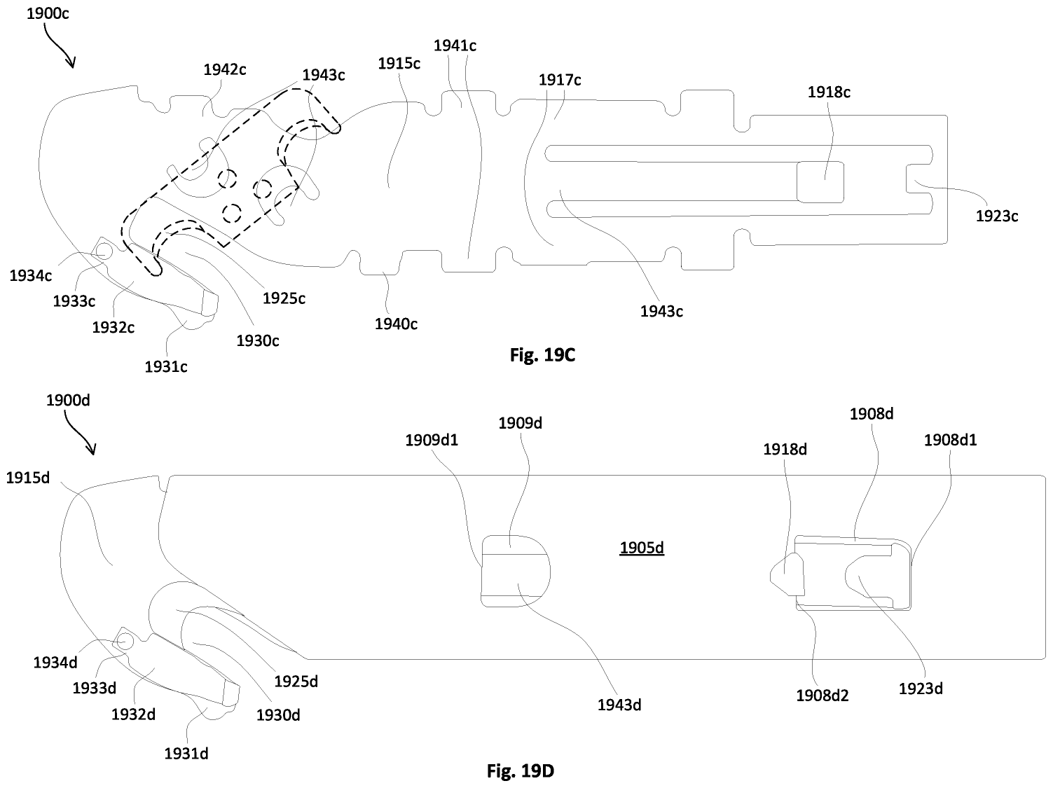

With reference to FIG. 28, a safety cutter assembly 2800 may include a handle 2805 injection molded of a polypropylene copolymer (e.g., polypropylene (PP)) with a first antimicrobial material (e.g., SANAFOR® PO-5 or SANAFOR® EBA-10) incorporated within the polypropylene copolymer.

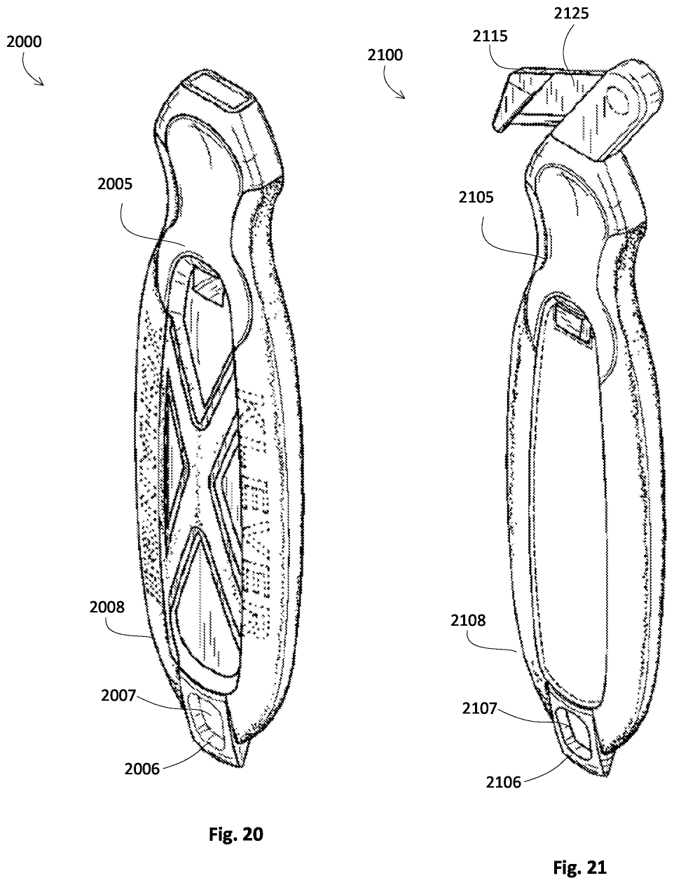

Turning to FIG. 29, a safety cutter assembly 2900 may include a handle 2905, having an integral blade retainer 2915, injection molded of a nylon (e.g., polycaprolactam/Nylon (PA6), Nylon 66, etc.) with a first antimicrobial material (e.g., a BioCote® silver ion material) incorporated within the nylon. The handle 2905 may include a lanyard attachment aperture 2907. The blade 2925 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 2905 and/or the integral blade retainer 2915 may include a metallic material embedded in the associated plastic material.

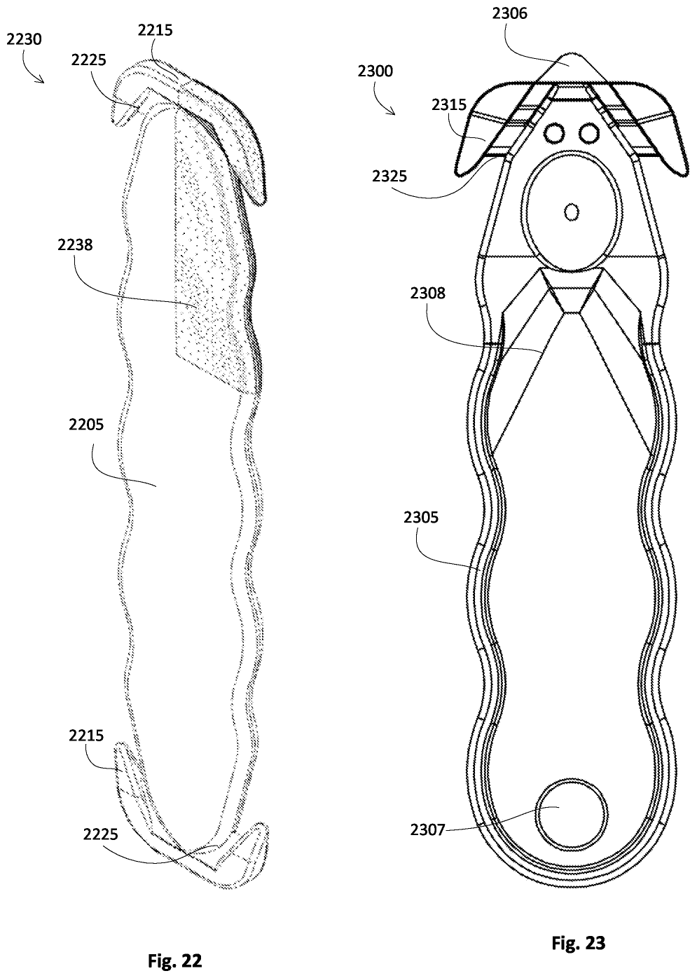

With reference to FIG. 30, a blade dispenser 3000 may include a housing 2805, having a lid hingingly attached to a base, injection molded of a polypropylene copolymer (e.g., polypropylene (PP)) with a first antimicrobial material (e.g., SANAFOR® PO-5 or SANAFOR® EBA-10) incorporated within the polypropylene copolymer.

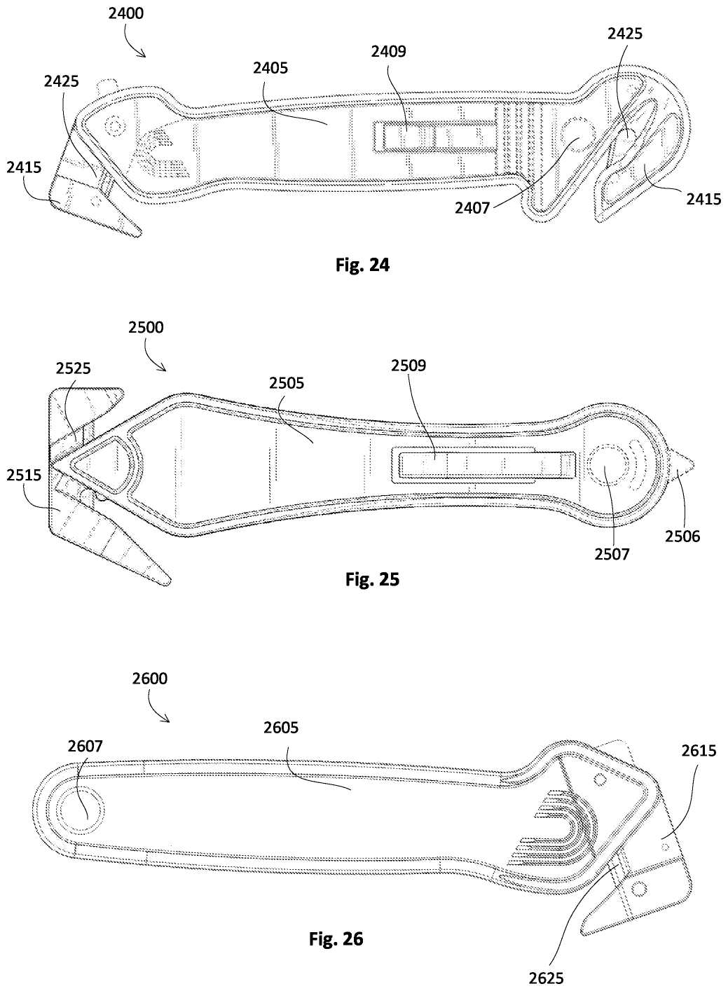

Turning to FIG. 31, a safety cutter assembly 3100 may include a handle 3105 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 3100 may include a replaceable blade retainer 3115 injection molded of a nylon (e.g., polycaprolactam/Nylon (PA6), Nylon 66, etc.) with a second antimicrobial material (e.g., a BioCote® silver ion material) incorporated within the nylon. Additionally, any one of, or each of, the handle 3105 and/or the blade retainer 3115 may include a metallic material embedded in the associated plastic material.

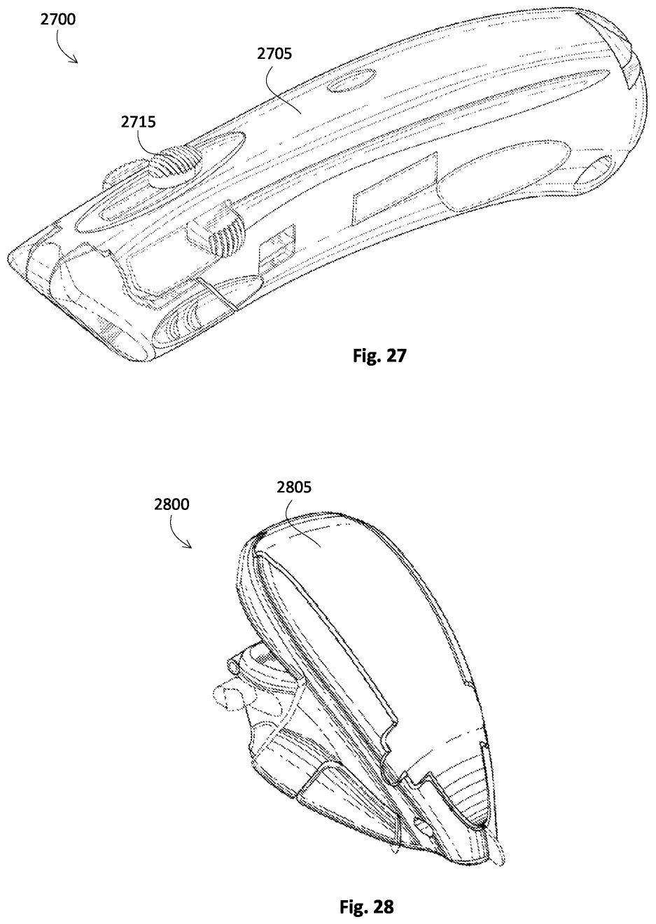

With reference to FIG. 32, a safety cutter assembly 3200 may include a handle 3205, having an integral blade retainer 3215, injection molded of a nylon (e.g., polycaprolactam/Nylon (PA6), Nylon 66, etc.) with a first antimicrobial material (e.g., a BioCote® silver ion material) incorporated within the nylon. The handle 3205 may include a material pierce 3206 and a lanyard attachment aperture 3207. The blade 3225 may be made from an antimicrobial material (e.g., stainless steel), or may be made, for example, from carbon steel and include an antimicrobial coating (e.g., silver, silver ion, copper, zinc, etc.). Additionally, any one of, or each of, the handle 3205 and/or the integral blade retainer 3215 may include a metallic material embedded in the associated plastic material.

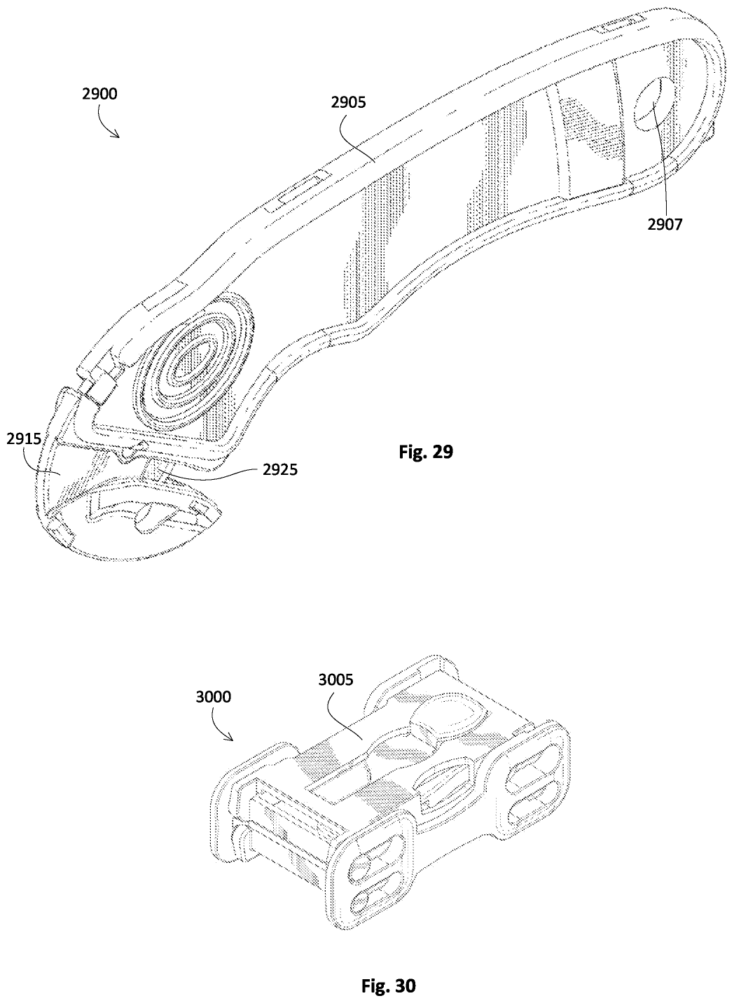

Turning to FIG. 33, a safety cutter assembly 3300 may include a handle 3305 injection molded of a polypropylene copolymer (e.g., polypropylene (PP)) with a first antimicrobial material (e.g., SANAFOR® PO-5 or SANAFOR® EBA-10) incorporated within the polypropylene copolymer. The first and second blades 3225 may be made from an antimicrobial material (e.g., stainless steel), or may be made, for example, from carbon steel and include an antimicrobial coating (e.g., silver, silver ion, copper, zinc, etc.). Additionally, the handle 3305 may include a metallic material embedded in the associated plastic material.

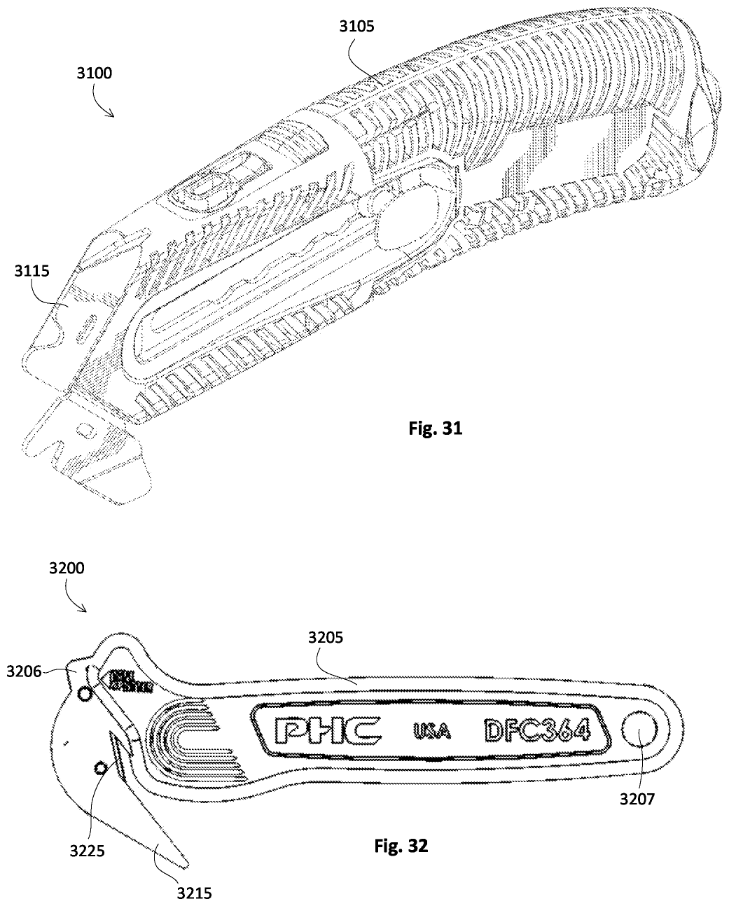

With reference to FIG. 34, a safety cutter assembly 3400 may include a handle 3405 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 3100 may include a replaceable blade retainer 3415 injection molded of a nylon (e.g., polycaprolactam/Nylon (PA6), Nylon 66, etc.) with a second antimicrobial material (e.g., a BioCote® silver ion material) incorporated within the nylon. Additionally, any one of, or each of, the handle 3405 and/or the blade retainer 3415 may include a metallic material embedded in the associated plastic material.

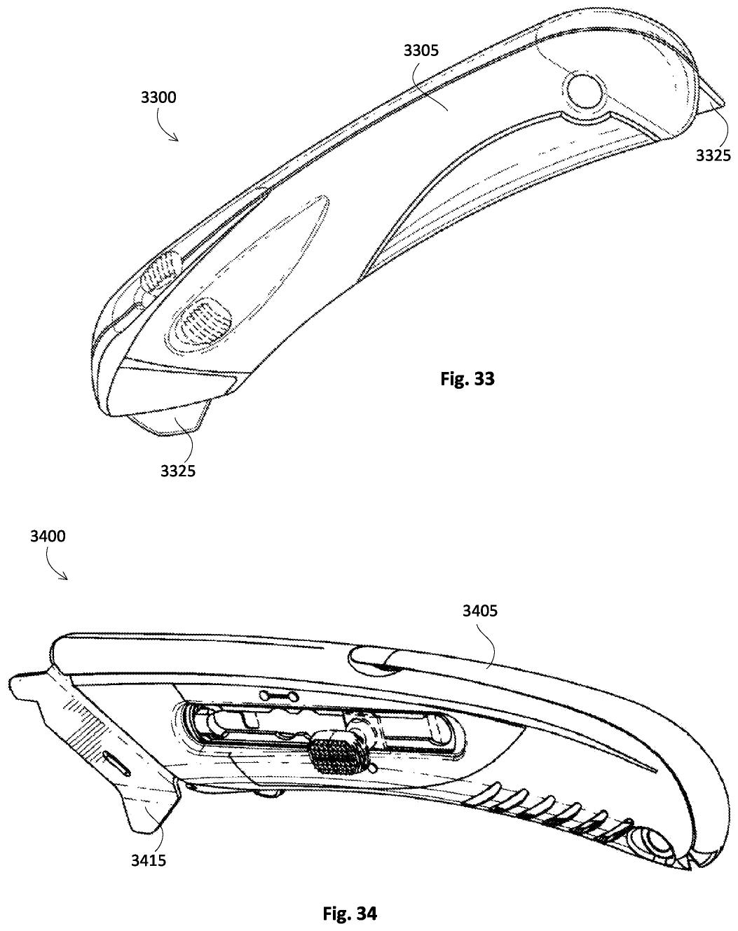

Turning to FIG. 35, a safety cutter assembly 3500 may include a handle 3505 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 3500 may include a replaceable blade retainer 3515 injection molded of a nylon (e.g., polycaprolactam/Nylon (PA6), Nylon 66, etc.) with a second antimicrobial material (e.g., a BioCote® silver ion material) incorporated within the nylon. Additionally, any one of, or each of, the handle 3505 and/or the blade retainer 3515 may include a metallic material embedded in the associated plastic material. As illustrated, the handle 3505 may be rotatable with respect the blade retainer 3515 resulting in an ambidextrous configuration.

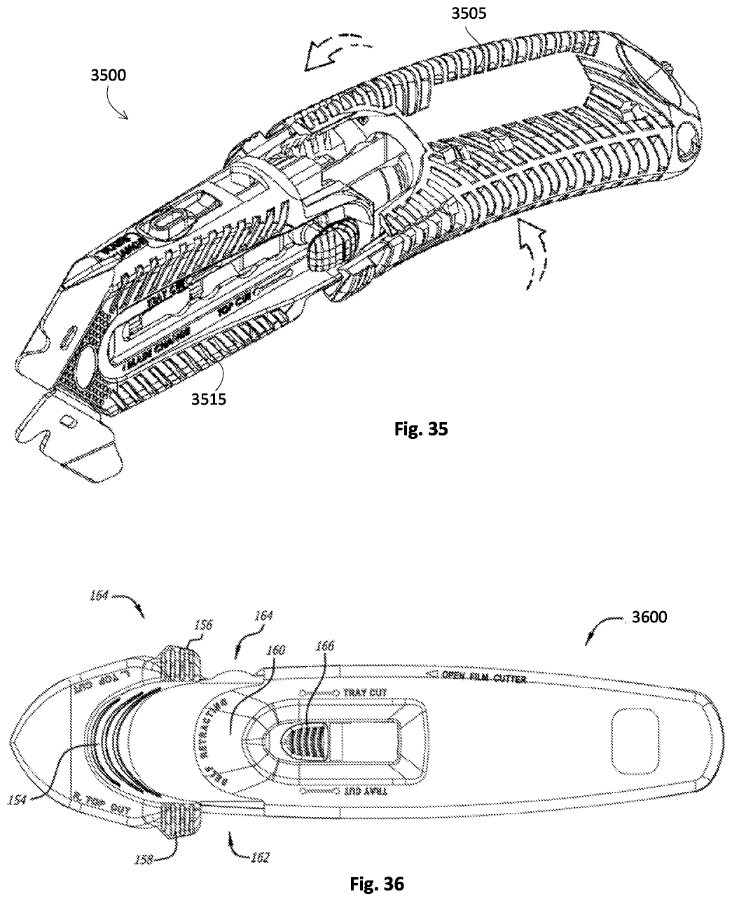

With reference to FIG. 36, a safety cutter assembly 3600 may include a handle 3605 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 3600 may include a replaceable blade retainer 3615 injection molded of a nylon (e.g., polycaprolactam/Nylon (PA6), Nylon 66, etc.) with a second antimicrobial material (e.g., a BioCote® silver ion material) incorporated within the nylon. Additionally, any one of, or each of, the handle 3605 and/or the blade retainer 3615 may include a metallic material embedded in the associated plastic material.

The safety cutter 3600 may include a housing 102, a slider 104, and a blade guard 106 (which also functions as a cutting guide). In this example embodiment, the housing 102 includes an upper housing portion 108, a backbone structure 110, and a lower housing portion 112 formed as shown to facilitate being inter-fitted together during assembly. For example, the upper housing portion 108, the backbone structure 110, and/or the lower housing portion 112 may be designed (i.e., formed), as shown, to mate the upper housing portion 108, the backbone structure 110, and/or the lower housing portion 112 during assembly of the housing 102. Alternatively, or additionally, the upper housing portion 108, the backbone structure 110, and/or the lower housing portion 112 may be designed (i.e., formed), as shown, to facilitate assembly of a safety cutter 3600. Furthermore, the upper housing portion 108, the backbone structure 110, and/or the lower housing portion 112 may be designed to facilitate injunction molding (e.g., associated mold design) of the upper housing portion 108, the backbone structure 110, and/or the lower housing portion 112. The upper housing portion 108 includes a slider window 114, and the lower housing portion 112 includes a dial window 116. The backbone structure 110, by way of example, can be formed from a rigid material such as zinc. In this example embodiment, the backbone structure 110 includes a tape splitter 118 shaped and positioned as shown adjacent to the blade guard 106.

Any of, or all of the housing 102, the slider 104, the blade guard 106, the upper housing portion 108, the backbone structure 110, and/or the lower housing portion 112 may be manufactured of a plastic material and antimicrobial material as, for example, described elsewhere wherein. Furthermore, any one of the housing 102, the slider 104, the blade guard 106, the upper housing portion 108, the backbone structure 110, and/or the lower housing portion 112 may be manufactured from any antimicrobial material as, for example, described elsewhere herein, and/or given plastic material, and any other of the housing 102, the slider 104, the blade guard 106, the upper housing portion 108, the backbone structure 110, and/or the lower housing portion 112 may be manufactured of any other antimicrobial material and/or given plastic material as, for example, described elsewhere herein.

A blade retention/release assembly 120 (discussed below in greater detail) is secured within the housing 102. The slider 104 is supported within the backbone structure 110 by channels 122, 124. A front blade 126 is supported by the top surface 128 of the slider 104. A cover plate 130 is supported at its forward end by surface 132 of the backbone structure 110. The blade guard 106, in turn, is positioned over the cover plate 130 and supported within the housing 102 such that the blade guard 106 can be slid longitudinally. In this example embodiment, the blade guard 106 includes follower posts 134, 136 which respectively make contact with surfaces 138, 140, of the slider 104 when the blade guard 106 is slid forward.

The safety cutter 3600 in operation with the front blade 126 being extended to a partially-extended (“top cut”) position in response to the blade guard 106 being pushed forward. During this motion, force applied (by a user of the cutter apparatus 100) to the blade guard 106 overcomes a counterbias applied by a guard spring 142, which is secured as shown between a retention hook 144 (of the blade guard 106) and a post 146 (of the backbone structure 110). This force also must overcome a counterbias applied by a slider spring 148, which is secured as shown between a post 150 (of the slider 104) and a post 152 (of the backbone structure 110). In this example embodiment, the blade guard 106 and the slider 104 are independently spring biased. A slider 104 and the blade guard 106 are configured to move in tandem as the blade guard 106 is deployed. In an example embodiment, a cutter apparatus includes a housing shaped to be hand-held, a slider configured to support a front blade, the slider being mechanically coupled to the housing and configured to be moved longitudinally along the housing, and a blade guard mechanically coupled to the housing and configured to be extended and retracted adjacent to the front end of the housing, wherein the slider and the blade guard are configured to move in tandem. The blade guard 106 includes one or more ergonomically designed surfaces or portions for pushing the blade guard 106 forward. In this example embodiment, the blade guard 106 includes a center grip portion 154 and two adjacent side grip portions 156, 158 formed as shown. In this example embodiment, the center grip portion 154 extends above a top surface 160 of the housing 102, and the side grip portions 156, 158 extend wider than the housing 102.

In operation, some users of the safety cutter 3600 may find that the quickest and easiest way to deploy the front blade 126, e.g., to “top cut” a box, is to use their thumb to press the center grip portion 154 forward and hold it in that forward position during the cutting motion. When the user lets go of the blade guard 106, the blade guard 106 is retracted backward by the guard spring 142. This backward motion of the blade guard 106, in turn, releases the slider 104 to be retracted backward by the slider spring 148. For extended intervals of cutting, some users of the safety cutter 3600 may find it more comfortable to position a finger behind one or both of the side grip portions 156, 158. In this example embodiment, the housing 102 includes recesses 162, 164 which further enhance gripping comfort when using the side grip portions 156, 158, respectively. The safety cutter 3600 in operation with the front blade 126 being extended to a fully-extended (“tray cut”) position in response to the slider 104 being directly pushed forward. More specifically, when a button 166 of the slider 104 is pressed forward by a user of the cutter apparatus 100,

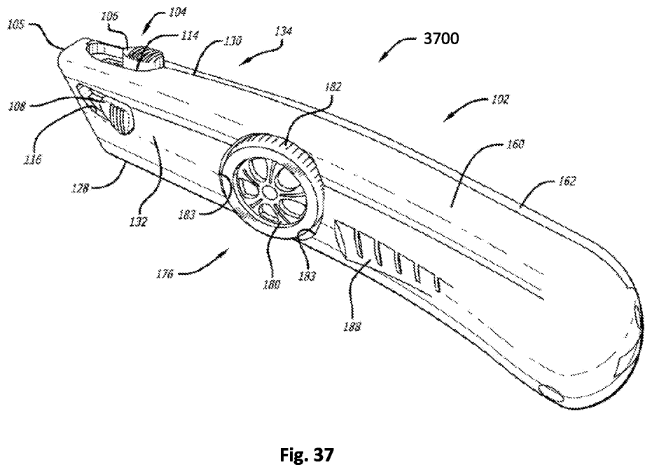

Turning to FIG. 37, a safety cutter assembly 3700 may include a handle 3705 injection molded of a polypropylene copolymer (e.g., polypropylene (PP)) with a first antimicrobial material (e.g., SANAFOR® PO-5 or SANAFOR® EBA-10) incorporated within the polypropylene copolymer. The safety utility knife assembly 3700 may include a replaceable blade retainer 3715 injection molded of a nylon (e.g., polycaprolactam/Nylon (PA6), Nylon 66, etc.) with a second antimicrobial material (e.g., a BioCote® silver ion material) incorporated within the nylon. Additionally, any one of, or each of, the handle 3705 and/or the blade retainer 3715 may include a metallic material embedded in the associated plastic material.

The safety utility knife assembly 3700 may include a housing 102, a blade carrier 104, and a mechanism for biasing the blade carrier 104 toward a retracted position away from a distal end 105 of the housing. The blade carrier 104 may be a “triple locking slider” which may include a top engaging portion 106, a left engaging portion 108, and a right engaging portion 110 formed as shown. The housing 102 may include a channel 112 and openings 114, 116 and 118 which are adjacent to the channel 112. In an example embodiment, the openings 114, 116 and 118 are approximately equidistant from the distal end 105 of the housing. The blade carrier 104 may be sized to fit within and slide along the channel 112 with its top, left and right engaging portions 106, 108 and 110 extending from the openings 114, 116 and 118, respectively. The housing 102 and the blade carrier 104 are shaped such that a cutting force (represented by arrow 119) applied to the housing when the blade carrier is in an extended position causes a top edge 120 of the blade carrier to come into contact with the housing frictionally locking the blade carrier in the extended position until the cutting force is removed. More specifically, when a counterforce (represented by arrow 121) is applied to a blade which is secured to the blade carrier 104, the top edge 120 of the blade carrier is forced against the housing. Adjacent to the distal end 105 of the housing 102, a portion 122 of the channel 112 is complementary in shape to the top edge 120 of the blade carrier 104, which facilitates the friction locking described above.

The safety utility knife assembly 3700 may include a housing (e.g., sized to be hand-held) and a blade carrier. The housing includes a channel and openings adjacent to the channel at three different sides of the housing. The blade carrier is sized to fit within and slide along the channel, and includes three engaging portions that extend from the openings such that a force bearing upon any of the portions can cause the blade carrier to slide along the channel. The blade carrier 104 is configured to secure a blade 124 to the cutter apparatus 100 such that a cutting edge 126 of the blade faces a bottom side 128 of the housing, and the three engaging portions 106, 108 and 110 extend from a top side 130, a left side 132, and a right side 134 of the housing, respectively. One or more of the engaging portions 106, 108 and 110 can include a gripping surface (e.g., ridges) 136. The blade carrier 104 can include one or more surfaces that are complementary to the blade 124. In the example embodiment described herein, the blade carrier 104 includes complementary surfaces 138, 140, 142, 144 and 146 which are formed as shown for preventing the blade 124 from sliding over the blade carrier. In this example embodiment, the blade carrier 104 also includes a tab member 148 under which the blade 124 is fitted. The tab member 148, in conjunction with rails 150 and 152 of the housing 102, prevents the blade 124 from falling away from the blade carrier 104 when the housing is assembled. In this example embodiment, the blade carrier 104 also includes a detent 154, and the mechanism for biasing the blade carrier 104 is a spring 156 which mechanically couples the blade carrier (at the detent 154) to a back portion 158 (e.g., a post) of the housing.

The housing 102 includes two housing portions 160 and 162 that are pivotally coupled together. By way of example, the housing portions 160 and 162 are formed with complementary end portions through which a pin 164 is inserted to effect a pivotal interconnection. In this example embodiment, the housing portion 162 includes an indented portion 166 sized to receive spare blades 168, and the housing portion 160 is provided with a spring 170 which is compressed between the housing portion 160 and an edge 172 of the indented portion 166.

The cutter apparatus 100 further includes a mechanism for securing the housing portions 160 and 162 together. In this example embodiment, the housing portion 162 includes a threaded channel 174, and the mechanism for securing includes a screw 176 with a threaded surface 178 complementary to the threaded channel 174. By way of example, the screw 176 includes a head 180 with a perimeter portion 182 that can be rotated by a user of the cutting apparatus, but which is also inset within a recess 183 formed in the housing portion 160. Thus, in this example, the screw 176 is fitted through an opening 184 in the housing portion 160 and rotated into the threaded channel 174 to secure the housing portions 160 and 162 together. When the screw 176 is loosened and removed, a force exerted by the spring 170 pushes the housing portions 160 and 162 apart slightly to make it easier for a user to pry open the cutter apparatus 100 (e.g., to replace a blade on the blade carrier 104). In this example embodiment, the threaded surface 178 is formed within a post member 186, which also serves as a stop for the blade carrier 104 when the blade carrier is pulled by the spring 156 to its retracted position. In this example embodiment, the housing portions 160 and 162 also include ridges outer surface portions 188.

An antimicrobial material may be effective with respect to pathogen organisms (e.g., Escherichia coli, Staphylococcus aureus, MRSA, Klegsiella pneumonia, Pseudomonas aeruginosa, Enterococcus faecalis, Acinetobacter baumannii, Proteus vulgaris, vancomycin-resistant Enterococcus, Candida albicans, Candid auris, etc.). For example, BioCote® antimicrobial material may be effective with a reduction of 90% in 2 hours against feline coronavirus, strain Munich. The feline coronavirus, strain Munich is a surrogate virus used in laboratories as a close but safer alternative to human pathogenic strains of coronavirus.

A virus is an infectious particle made up of a core of genetic material surrounded by a protective coat made up of proteins, known as a capsid. Some viruses also have a secondary spikey coat surrounding the capsid known as an envelope. Viruses are known as obligate intracellular parasites as, unlike most bacteria, viruses can only replicate within a living host cell. Viruses do not possess the capability to carry out metabolic processes and rely solely on a cell of a living host to form proteins and multiply. Due to this, viruses are defined as non-living entities. The aim of any virus is to replicate and spread their genetic material to other living hosts.

Bacteria, on the other hand, are considered a living entity as, generally, bacteria are capable of functioning independently of host cells and carrying out metabolic processes. Whilst many opportunistic bacteria thrive comfortably within the body of a mammal at 37° C., bacteria are still capable of surviving in unfavorable conditions for long periods of time on inanimate surfaces.

Coronaviruses are a large family of zoonotic viruses, meaning coronaviruses can pass from animal or insect to humans upon mutation. Coronaviruses are so named after the Latin word “corona”, meaning “crown” or “halo” due to their microscopic appearance. This crown of proteins help the virus identify whether it can infect its host.

There are seven coronaviruses known to cause disease in humans, four of which are considered mild in their pathogenicity: viruses 229E, OC43, NL63 and HKU1. However, the remaining strains of coronavirus have the ability to cause more serious diseases in humans. SARS (severe acute respiratory syndrome, or SARS-CoV-1) emerged in late 2002 with a record of 774 deaths, followed by MERS (Middle East respiratory syndrome, or MERS-CoV) in 2012. SARS-CoV-2 is the name given to the novel coronavirus identified in 2019 which is a new strain of coronavirus previously unidentified in humans. COVID-19 is the name given to the disease caused by the virus.

The difference between coronaviruses and SARS-CoV-2 (COVID-19) lies with mutation and pathogenicity of the virus. As previously mentioned, whilst four of the currently known strains of coronavirus are considered mild in their pathogenicity to cause disease in humans, the other strains have required a genetic mutation which allows them to transfer not only from human to human transmission but with increased pathogenicity.

BioCote® has proven efficacy against feline coronavirus, strain Munich, with a reduction of 90% in 2 hours. However, this should not be used for claims against the novel virus SARS-CoV-2 (COVID-19). Whilst the result against feline coronavirus, strain Munich, clearly demonstrate the antiviral efficacy of BioCote® technology against a member of the coronavirus family, it cannot be known whether SARS-CoV-2 exhibits virulence properties which are not affected by silver without testing this strain. To confirm with certainty whether the virulence properties of SARS-CoV-2 (COVID-19) are affected by BioCote® technology, the testing will need to be repeated on the actual SARS-CoV-2 (COVID-19) strain. The Centers for Disease Control and Prevention (CDC) has categorised the virus at biohazard level 3 and above, meaning the SARS-CoV-2 virus will not currently be available for public commercial testing at this point in the pandemic.

The following demonstrates an evolutionary relationship between the feline coronavirus, strain Munich and SARS-CoV-2. Feline coronavirus: Realm—Riboviria; Order—Nidovirales; Family—Coronaviridae; Genus—Alphacoronavirus; and Species—Alphacoronavirus 1. SARS-CoV-2 (COVID-19): Realm—Riboviria; Order—Nidovirales; Family—Coronaviridae; Genus—Betacoronavirus; and Species—1 COVID-19. Whilst the two strains of coronavirus are within the same family, they separate at genus in to alphacoronavirus and betacoronavirus. The differences between the two genera are not entirely clear, however previous studies suggest that betacoronaviruses have low host-specificity and evolve by host-switching and recombination (cells infected by more than one virus potentially creating new strains). In contrast, alphacoronaviruses are thought to be more specific in their hosts. Feline coronavirus is in the same family, therefore shares almost identical structure and is very similar. The difference being that they begin to separate at the genus whereby it is suggested that SARS-CoV-2 has lower host specificity (targets more hosts such as humans, bats, pangolins and snakes) whereas the strain feline coronavirus has more host specificity (transmission in cats only). In other words, the difference between the two appears to be the cells that they adhere to (human cells and feline cells). However, at this moment in time not enough is known about SARS-CoV-2 to know if there are more similarities.

A study found that the SARS-CoV-2 strain of coronavirus has a few mutations that form a particularly compact ‘ridge’ in the spike protein. This compact ridge may result in tighter binding to its human receptor through evolution and as a result, SARS-CoV-2 has become more efficient at infecting and causing disease in humans compared to its relative SARS-CoV-1 (SARS 2002-2003).

The figures depict preferred embodiments of safety blades for use in utility knife assemblies, utility knife assemblies and methods of manufacturing. One skilled in the art will readily recognize from the corresponding written description that alternative embodiments of the structures and methods illustrated herein may be employed without departing from the principles described.

Upon reading this disclosure, those of skill in the art will appreciate still additional alternative structural and functional designs for safety blades for use in utility knife assemblies, utility knife assemblies and methods of manufacturing. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the apparatuses and methods disclosed herein without departing from the spirit and scope defined in the appended claims.

1. A safety cutter, comprising:
a blade;
a blade attachment; and
a handle, wherein the blade is attached to the handle via the blade attachment, and wherein at least one of: the blade attachment or the handle is either a thermoplastic resin material infused with an antimicrobial material or an antimicrobial material compounded with the thermoplastic resin material.

2. The safety cutter of claim 1, wherein a portion of the blade is co-molded within the blade attachment and the blade attachment is contiguously molded with the handle.

3. The safety cutter of claim 1, wherein the blade attachment includes a first thermoplastic resin material and the handle includes a second thermoplastic resin material, and wherein the first thermoplastic resin material is different than the second thermoplastic resin material.

4. The safety cutter of claim 3, wherein the blade attachment includes a first antimicrobial material and the handle includes a second antimicrobial material, and wherein the first antimicrobial material is different than the second antimicrobial material.

5. The safety cutter of claim 1, wherein the antimicrobial material is formulated into at least one of: a concentrated powder, a liquid suspension, or a master-batch pellet depending on the thermoplastic resin material.

6. The safety cutter of claim 1, wherein the antimicrobial material is formulated into at least one of: a concentrated powder, a liquid suspension, or a master-batch pellet depending on a safety cutter manufacturing process blade.

7. The safety cutter of claim 1, wherein the blade attachment defines a first blade throat configured to limit access to a first cutting edge of the blade and a second blade throat configured to limit access to a second cutting edge of the blade, wherein the first cutting edge extends from a first edge of the handle, wherein the second cutting edge extends from a second edge of the handle, wherein the second edge of the handle is opposite the first edge of the handle.

8. (canceled)

9. A method of manufacturing a safety cutter, comprising:
providing a blade,
a blade attachment and
a handle, wherein at least one of: the blade attachment or the handle is either a thermoplastic resin material infused with an antimicrobial material or an antimicrobial material compounded with the thermoplastic resin material.

10. (canceled)

10. (canceled)

11. (canceled)

12. The method of claim 9, wherein the antimicrobial material is formulated into at least one of: a concentrated powder, a liquid suspension, or a master-batch pellet depending on the thermoplastic resin material.

13. The method of claim 9, wherein the antimicrobial material is formulated into at least one of: a concentrated powder, a liquid suspension, or a master-batch pellet depending on a safety cutter manufacturing process blade.

14. The method of claim 9, wherein the blade attachment defines a first blade throat configured to limit access to a first cutting edge of the blade and a second blade throat configured to limit access to a second cutting edge of the blade, wherein the first cutting edge extends from a first edge of the handle, wherein the second cutting edge extends from a second edge of the handle, wherein the second edge of the handle is opposite the first edge of the handle.

15. The method of claim 9, wherein the blade attachment defines a blade throat configured to limit access to a cutting edge of the blade.

16. (canceled)

17. (canceled)

18. (canceled)

19. (canceled)

20. (canceled)

21. The method of claim 9, further comprising:
co-molding a portion of the blade within the blade attachment contiguous with the handle.

22. The method of claim 9, wherein the blade attachment includes a first thermoplastic resin material and the handle includes a second thermoplastic resin material, and wherein the first thermoplastic resin material is different than the second thermoplastic resin material.

23. The method of claim 22, wherein the blade attachment includes a first antimicrobial material and the handle includes a second antimicrobial material, and wherein the first antimicrobial material is different than the second antimicrobial material.

24. A safety cutter head, comprising:
a blade attached to a blade attachment, wherein the blade attachment is either a thermoplastic resin material infused with an antimicrobial material or an antimicrobial material compounded with the thermoplastic resin material.

25. The safety cutter head of claim 24, wherein a portion of the blade is co-molded within the blade attachment and the blade attachment.

26. The safety cutter head of claim 25, wherein the blade attachment defines a first blade throat configured to limit access to a first cutting edge of the blade and a second blade throat configured to limit access to a second cutting edge of the blade, wherein the first cutting edge extends from a first edge of the blade attachment, wherein the second cutting edge extends from a second edge of the blade attachment, wherein the second edge of the blade attachment is opposite the first edge of the blade attachment.

27. The safety cutter head of claim 24, wherein the antimicrobial material is formulated into at least one of: a concentrated powder, a liquid suspension, or a master-batch pellet depending on the thermoplastic resin material.

28. The safety cutter head of claim 24, wherein the thermoplastic resin material is nylon and the antimicrobial material includes zinc.
